(19) United States
(12) Patent Application Publication
(10) Pub. No.: US 2015/0345068 A1
(43) Pub. Date: Dec. 3, 2015

(54) USER CONTROL INTERFACE FOR AN APPLIANCE, AND ASSOCIATED METHOD

(71) Applicant: Electrolux Home Products, Inc., Charlotte, NC (US)

(72) Inventors: Hayoung Coffman, Charlotte, NC (US); Charlotte Brundin, Anderson, SC (US)

(21) Appl. No.: 14/821,400

(22) Filed: Aug. 7, 2015

Related U.S. Application Data
(63) Continuation of application No. PCT/US2014/015047, filed on Feb. 6, 2014.
(60) Provisional application No. 61/761,813, filed on Feb. 7, 2013.

(51) Int. Cl. D06F 39/00; D06F 33/02; G06F 3/0482; G06F 3/0484; G06F 3/0481; D06F 58/28; G06F 3/0488

(52) U.S. Cl. CPC D06F 39/005; D06F 58/28; D06F 33/02; G06F 3/0488; G06F 3/04847; G06F 3/04817; G06F 3/0482; G06F 3/04842; D06F 2058/2803; D06F 2058/2883; D06F 2216/00; D06F 2214/00

(57) ABSTRACT

A touchscreen user interface and is provided for controlling an appliance. The appliance includes a controller device configured to direct operation of at least one operational component associated with the appliance in response to at least one user selection via a touchscreen user interface in communication with the controller device. The touchscreen user interface has a display screen for displaying a series of cycle icons, each cycle icon being associated with a respective cycle capable of being implemented via the controller device. The series of cycle icons may be scrollable across the display screen in opposing first and second scrolling directions. Each cycle icon may be individually selectable via the at least one user selection via interaction with the touchscreen user interface such that a selected one of the cycle icons may be centered and enlarged within the series of laundry cycle icons.

### BACKGROUND

1. Field of the Disclosure

Aspects of the present disclosure relate generally to appliances and, more particularly, to a user control interface for a laundry appliance and an associated method for controlling a laundry appliance.

2. Description of Related Art

Certain laundry appliances, such as a washing machine or dryer, may include a controller or other control unit in electrical communication with one or more user interfaces or other control elements. Various operational components of the laundry appliance are thus controlled via the controller/control unit in response to various commands or user selections for controlling such components initiated through the user interface/control elements.

In some instances, the user interface may include various configurations of actuatable elements for permitting user selection from among a plurality of laundry cycles and/or other parameters associated with the laundry cycles. For example, a rotational-selection knob may be provided on a control panel of the laundry appliance, wherein the user rotates the selection knob to the desired laundry cycle or cycle segment, and then actuates an actuator to initiate the laundry cycle. In some instances, another physical button or knob may be provided for altering one or more of the default settings associated with the selected laundry cycle. Such configurations of physical elements, however, may only provide limited usability and user-friendliness for the user. For example, only a limited number of laundry cycles may be provided due to physical constraints (e.g., size) of the control interface or selection device of the laundry appliance. Further, such configurations may not necessarily allow for personalization or customization of the laundry appliance to correspond to the preferences of the user or users.

Thus, it would be desirable to provide a control interface and associated method for controlling a laundry appliance with improved usability and user-friendliness. Such a solution should also be capable of implementing control configurations which are intuitive to the user, while providing more or a variety of options to the user. Further, such a solution should desirably provide personalization and customization capabilities such that one or more users can customize the laundry appliance for personal use, and should desirably do so in a functionally practical manner.

### BRIEF SUMMARY

The above and other needs are met by the present disclosure which, according to one aspect, provides a laundry appliance having a controller device configured to direct operation of at least one operational component associated with the laundry appliance. Such a laundry appliance further includes a touchscreen user interface in communication with the controller device, wherein the controller device is responsive to at least one user selection via the touchscreen user interface to direct operation of the at least one operational component. The touchscreen user interface has a display screen for displaying a series of laundry cycle icons, with each laundry cycle icon being associated with a respective laundry cycle capable of being implemented via the controller device. The laundry cycle icons may more specifically be in the form of wash and/or dry cycle icons, and the laundry cycles may more specifically be in the form of wash and/or dry cycles.

The series of laundry cycle icons may be scrollable across the display screen in opposing first and second scrolling directions. Each laundry cycle icon is individually selectable via the at least one user selection via user touch interaction with the touchscreen user interface, such that a selected one of the displayed laundry cycle icons is distinguished relative to the other laundry cycle icons, to indicate selection thereof. For example, the selected one of the displayed laundry cycle icons may be visually distinguished by being centered and enlarged within at least a portion of the series of laundry cycle icons.

Another aspect of the present disclosure provides a method of controlling a laundry appliance. Such a method comprises displaying a series of laundry cycle icons on a display screen of a touchscreen user interface associated with the laundry appliance. The touchscreen user interface is in communication with a controller device configured to direct operation of at least one operational component associated with the laundry appliance in response to at least one user selection via the touchscreen user interface. Each laundry cycle icon is associated with a respective laundry cycle capable of being implemented via the controller device. Each laundry cycle icon is individually selectable via user touch interaction with the touchscreen user interface such that a selected one of the displayed laundry cycle icons is distinguished (e.g., centered and enlarged) within the series of laundry cycle icons to indicate selection thereof. Such a method may further comprise scrolling the series of laundry cycle icons across the display screen in one of a first and second scrolling direction.

Numerous other aspects are within the scope of the present disclosure. For example, some aspects of this disclosure relate to creating/storing a new and/or modified laundry cycle (e.g., a favorite laundry cycle) so that it is available for future selection by a user.

The foregoing presents a simplified summary of some aspects of this disclosure in order to provide a basic understanding. The foregoing summary is not an extensive summary and is not intended to identify key or critical elements of the invention or to delineate the scope of the invention. The purpose of the foregoing summary is to present some concepts of this disclosure in a simplified form as a prelude to the more detailed description that is presented below. For example, other aspects will become apparent from the following.

### BRIEF DESCRIPTION OF THE SEVERAL VIEWS OF THE DRAWING(S)

Having thus described some aspects of the disclosure in general terms, reference will now be made to the accompanying drawings, which are not necessarily drawn to scale and may be schematic, and wherein:

FIG. 1 is a perspective view of a washing appliance control panel having a touchscreen user interface, according to one aspect of the present disclosure;

FIGS. 2-6 illustrate a washing appliance touchscreen user interface displaying a series of selectable and scrollable wash cycle icons, according to one aspect of the present disclosure;

FIGS. 7 and 8 illustrate a washing appliance touchscreen user interface displaying a plurality of selectable cycle group icons, according to one aspect of the present disclosure;

FIGS. 9 and 10 illustrate a washing appliance touchscreen user interface displaying wash cycle information associated with a selected wash cycle, the information being superimposed over at least a portion of a selected wash cycle icon, according to one aspect of the present disclosure;

FIGS. 11 and 12 illustrate a washing appliance touchscreen user interface displaying a plurality of scrollable cycle parameter settings, according to one aspect of the present disclosure;

FIGS. 13 and 14 illustrate a washing appliance touchscreen user interface displaying a collection of selectable option icons, according to one aspect of the present disclosure;

FIGS. 15 and 16 illustrate a washing appliance touchscreen user interface displaying a plurality of start delay option icons, according to one aspect of the present disclosure;

FIG. 17 illustrates a washing appliance touchscreen user interface displaying information associated with a selected wash cycle, according to one aspect of the present disclosure;

FIGS. 18-21 illustrate a washing appliance touchscreen user interface displaying wash cycle status displays, according to one aspect of the present disclosure;

FIG. 22 illustrates a washing appliance touchscreen user interface displaying a collection of selectable option icons accessible by scrolling away from the wash cycle status display shown in FIGS. 20 and 21, according to one aspect of the present disclosure;

FIG. 23 illustrates a washing appliance touchscreen user interface displaying, for example, icons, one of which may be selected to initiate the saving of a favorite wash cycle (e.g., a new wash cycle) and/or a favorite wash cycle icon (e.g., a new wash cycle icon), according to one aspect of this disclosure;

FIGS. 24 and 25 illustrate a washing appliance touchscreen user interface displaying, for example, a virtual keyboard that may be used to customize a textual (e.g., name) portion of a favorite wash cycle icon (e.g., a new wash cycle icon), according to one aspect of this disclosure;

FIG. 26 illustrates a washing appliance touchscreen user interface displaying and/or soliciting confirmation about the saving of a favorite wash cycle (e.g., a new wash cycle) and/or a favorite wash cycle icon (e.g., a new wash cycle icon), according to one aspect of this disclosure;

FIG. 27 illustrates a washing appliance touchscreen user interface displaying a plurality of selectable cycle group icons that has been updated to include a favorites icon for providing access to favorite wash cycle icon(s)/favorite wash cycle(s), according to one aspect of this disclosure;

FIG. 28 illustrates a drying appliance touchscreen user interface displaying a series of selectable and scrollable dry cycle icons, according to one aspect of this disclosure;

FIG. 29 illustrates a drying appliance touchscreen user interface displaying a plurality of scrollable cycle parameter settings, according to one aspect of this disclosure;

FIG. 30 illustrates a drying appliance touchscreen user interface displaying a collection of selectable option icons, according to one aspect of this disclosure; and

FIG. 31 illustrates a drying appliance touchscreen user interface displaying a dry cycle status display, according to one aspect of this disclosure.

### DETAILED DESCRIPTION

The present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

A laundry appliance (e.g., a washing appliance or a dryer appliance) typically includes a tub portion, supported within an enclosure, in which laundry may be placed for washing and/or drying. The tub portion may also define an access opening, whether about an upper surface of a forward surface thereof. A door assembly may be pivotably engaged with the tub portion or enclosure so as to selectively permit access to the interior of the tub portion via the access opening. A washing or drying drum is rotatably disposed within the tub portion of the respective washing and drying appliance for agitating or spinning the laundry during the washing or drying process. The laundry appliance includes particular operational components (e.g., pumps, valves, motors, etc.) for performing the operational functions thereof.

The laundry appliance may typically include a number of selectable laundry cycles, each representing a particular combination of various operational parameters associated with the laundering process. Such laundry cycles may be selectable by a user on a touchscreen user interface in communication with a controller device. The controller device may be housed within a control panel 100 associated with the laundry appliance, or otherwise within the enclosure thereof. The controller device may include or be in communication with a control circuit configured to vary the parameters of the appropriate components of the laundry appliance required to execute the laundry cycle selected by the user. That is, the controller device is configured to direct operation of at least one operational component associated with the laundry appliance in response to the laundry cycle or other parameters selected by the user.

In some instances, the user may select the laundry cycle by, for example, touching or otherwise actuating a virtual button or icon displayed on the touchscreen user interface 150, wherein the icon is associated with the desired laundry cycle. Upon user selection of the desired icon, a signal associated with the corresponding laundry cycle is directed to the control circuit for processing, wherein the controller device or other computer device is responsive to the signal to direct the various laundry appliance components to effectuate the parameters associated with the selected laundry cycle. Such parameters may include, for example, particular durations for each laundry cycle segment/event (e.g., a fill event, a rinse event, a spin event, a drying event) of the laundry cycle, the temperature of the water/air used by such segments/events, and the amount of water used during such wash segments/events. Accordingly, such parameters may be adjusted and controlled by the control circuit, including the controller device or other associated computer device, in communication with the laundry appliance components, as will be appreciated by one skilled in the art.

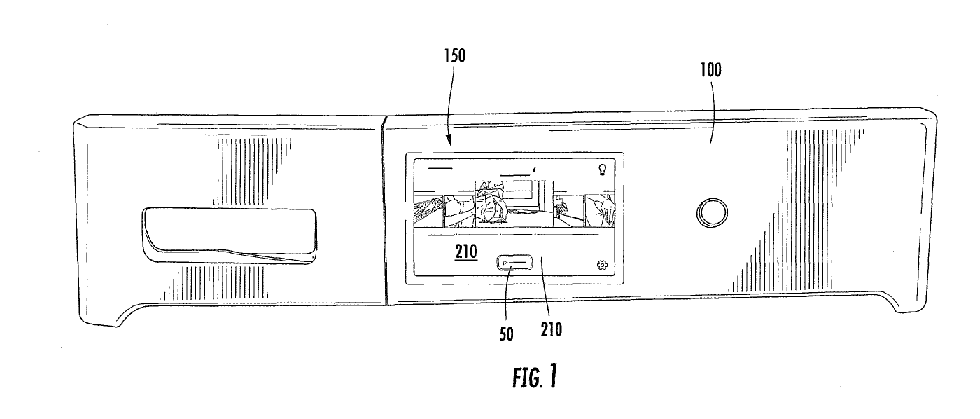

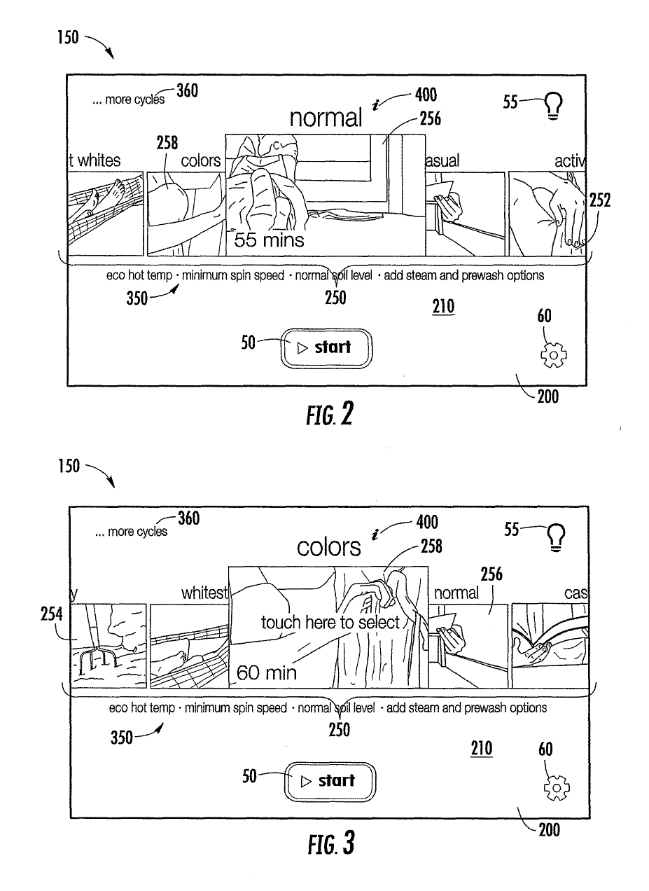

As disclosed, at least a portion of the controller device may be housed in or otherwise in communication with a control panel 100 having a touchscreen user interface 150, as shown in FIG. 1. A user interacts with the touchscreen user interface 150 via, for example, a display screen or display portion 200, to, for instance, select a laundry cycle, alter cycle parameters associated with a selected laundry cycle, or initiate/stop/pause a laundry cycle. The display portion 200 of the touchscreen user interface 150 may comprise a liquid crystal display (LCD) or other display device capable of providing graphics/images to the user. In some instances, the display portion 200 may be backlit by one or more lighting devices such as, for example, a light emitting diode (LED) device. In some instances, the touchscreen user interface 150 may be configured to present a plurality of virtual buttons or icons. Each icon may be configured to include graphics and/or text (i.e., a string of alphanumeric characters) to provide the user with an indicia of a position on, or area of, the display screen with which the user may interact (i.e., touch) in order to select the corresponding icon. In some instances, the icon may have the appearance on the display portion 200 of a physical button (i.e., via three-dimensional graphics imaging), while in other instances the icon may only appear as text, a graphic, or combinations thereof on the display portion 200. According to some aspects, the icon selected by the user, or otherwise configured as a default icon, may be visually-distinguished, highlighted or otherwise visually indicated as being selected on the display portion 200, as shown in FIGS. 1 and 2. FIGS. 1 and 2 illustrate a Normal wash cycle icon 256, which is associated with a normal wash cycle, as being selected by centering and enlarging the icon 256. As another example, FIG. 3 illustrates a Colors wash cycle icon 258, which is associated with a colors wash cycle, as being selected by centering and enlarging the Colors wash cycle icon 258. In some aspects, the icons may include animation to further provide an indication to the user of, for example, the selection of an icon, the location of an icon, or to otherwise identify a position or area on the display portion 200 defining an icon or how to further select a wash cycle icon 250 (see, e.g., FIG. 3 displaying the textual indicia “touch here to select”). Furthermore, in response to the selection of an icon, an aural indicia may be provided via an audio device (e.g., a speaker) and/or haptic feedback may be provided to the user via the display portion, as a confirmation of that selection.

As shown and disclosed herein, FIGS. 1-22 illustrate an exemplary control panel 100 and touchscreen user interface 150 for a washing appliance. A similar control panel and touchscreen user interface for a dryer appliance are also within the scope of this disclosure. As such, the general aspects disclosed herein with respect to either the washing appliance touchscreen user interface or the dryer appliance touchscreen user interface may be applicable to both the washing and dryer appliances, as will be appreciated by one skilled in the art.

As shown in FIGS. 1-6, a default arrangement provided on the touchscreen user interface 150/display portion 200 may be a main menu (home screen) display 210. The main menu display 210 on the display portion 200 may include a plurality of icons associated with the wash cycles and other wash- or machine-related icons. These icons may include, for example, a wash cycle initiation/cycle start icon 50, light icon 55, preferences icon 60 and/or others.

For example, another icon that may be displayed on the main menu display 210 is a lock icon (not shown) that may be illustrated in the form of a lock or a lock-like feature, and the lock icon may be adjacent the light icon 55, or in any other suitable location on the main menu display 210. In response to a user selecting the lock icon of the main menu display 210, a confirmation screen (not shown) may be displayed on the display portion 200, and the confirmation screen may include an a textual icon of “lock the control?”, and spaced apart textual icons of “no” and “yes” that may be selected by the user and are responsive for respectively allowing the user to cancel or confirm locking of the touchscreen user interface 150. When the touchscreen user interface 150 is locked, the display portion 200 may solely or substantially solely display a “locked” textual icon (not shown), which may be animated to schematically generally represent movement of tumblers of a lock, or the like. The “locked” textual icon may be responsive to being selected by the user to display a second confirmation screen (not shown) on the display portion 200. The second confirmation screen may include a textual icon of “unlock the control?”, and textual icons of “no” and “yes” that may be selected by the user and are responsive for respectively allowing the user to cancel or confirm unlocking of the touchscreen user interface 150. When the touchscreen user interface 150 is unlocked, the main menu display 210 may be displayed on the display portion 200. Passwords and/or other suitable features may be associated with the above-discussed locking features of this disclosure.

According to some particular aspects of the present disclosure, the main menu display 210 on the display portion 200 may present a plurality of selectable wash cycle icons 250 (e.g., Normal, Colors, Heavy Duty, Whitest Whites, Sanitize, Jeans, Pet Beds, Stuffed Animals, Adhesive, Beverages, Blood, Chocolate, Cosmetics, Dairy, Dyes, Grass, Grease, Ink, Mildew, Mud, Mustard, Nail Polish, Oil Based Paint, Perspiration, Rust, Shoe Polish, Tomato, Vomit, Water Based Paint, Wax, Wine, Towels, Kids Wear, Delicates, Ultra Delicate, Handwash, Wool, Silk, Clean Washer, Rinse & Spin, Active Wear, Express Sanitize, Bulky/Bedding, Casual, Express Wash, Steam Prewash, Refresh, Cold Clean, etc.) each associated with a respective wash cycle and being selectable by the user to select the desired wash cycle. The wash cycle icons 250 may be more generally referred to as laundry cycle icons.

In some instances, each wash cycle icon 250 includes text and/or a graphic particularly indicative of the associated wash cycle. In some particular instances, the graphic of the wash cycle icon 250 may be a photographic image. For example, the wash cycle recommended or otherwise configured as the default for normal laundry use may be displayed as the text “Normal” in addition to a graphic (e.g., photographic image), to form the Normal wash cycle icon 256, as shown in FIG. 2. In some instances, the wash cycle icons 250 may be displayed on the display portion 200 in a series or otherwise linearly along a horizontally-displayed row or a vertically-displayed column According to some aspects, the wash cycle icons 250 may be displayed in multiple series on the display portion 200, in rows, columns, or combinations thereof. That is, a first series of the wash cycle icons 250 could be provided on one side of the display portion 200, while a second series of wash cycle icons 250 could be provided on the opposing or adjacent side of the display portion 200, in rows, columns or a combination thereof.

Reiterating from above, each of the wash cycle icons 250 may comprise a graphic (e.g., photographic image), and the wash cycle icons may be arranged in one or more series. A wide variety of serial arrangements and graphics are within the scope of this disclosure. For example, a Cold Water Clean wash cycle icon (not shown) may be positioned between the Normal and Colors wash cycle icons 256, 258.

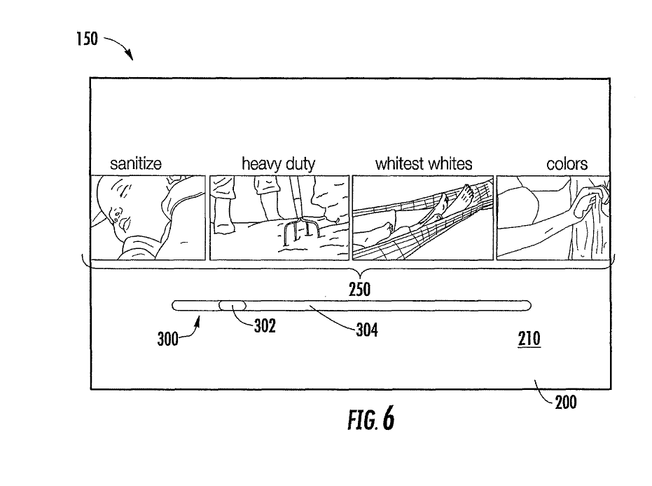

The graphics (e.g., photographic images) of the wash cycle icons 250 may be respectively suggestive of the associated wash cycle. For example and referring to FIG. 3, the graphics of a Heavy Duty wash cycle icon 254 may be a photograph that includes a pitch fork with its tines in the ground or some other substance. Alternatively, the graphics of the Heavy Duty wash cycle icon 254 may be a photograph of someone riding in a wheelbarrow being pushed by another person. Similarly, the graphics of the Colors wash cycle icon 258 may be a photograph of people walking on a beach in colorful clothing. That is, one or more of the photographs schematically illustrated, for example, in FIGS. 1-10, or each of those photographs, may be replaced with another suitable photograph or graphic. Similarly, a wide variety of names or texts may be associated with the wash cycle icons 250. For example, a Sanitize wash cycle icon (FIG. 6) may alternatively be referred to and/or displayed as a Deep Clean wash cycle icon (not shown).

As mentioned previously, a selected one of the wash cycle icons 250 may be visually-distinguished, or otherwise visually indicated, as selected when the user interacts via user touch interaction with the selected one of the wash cycle icons 250. According to one aspect of the present disclosure, the selected one of the wash cycle icon 250 may be centered and enlarged upon selection thereof. For example, as shown in FIG. 2, the Normal wash cycle icon 256 is indicated as the selected wash cycle due to its centered positioned and enlarged size, indicating to the user that actuation of the cycle start icon 50 would cause the normal wash cycle to be implemented. The selection of one of the wash cycle icons 250 is accomplished by user touch interaction with, for example, the desired wash cycle icon 250, the text that is associated or part of the desired wash cycle icon 250, and/or the graphic (e.g., photographic image) that is associated with or part of the desired wash cycle icon 250. For example, as shown in FIG. 3, the user has interacted with (e.g., touched on the display portion 200) the Colors wash cycle icon 258 so as to cause the Colors wash cycle icon 258 to be visually distinguished (e.g., centered and enlarged) with respect to the non-selected wash cycle icons 250 of the series of wash cycle icons. In one particular aspect, both the text and the graphic (e.g., photographic image) are enlarged compared to the non-selected wash cycle icons 250. It is within the scope of this disclosure for a wash cycle icon 250 to be indicated as being selected by various combinations of modifications to the text and graphic of the selected icon, and by way of visually distinguishing using techniques other than, or in addition to, the centering and/or enlarging disclosed herein.

According to some aspects of the present disclosure, only a limited (i.e., less than the total amount of wash cycle icons) or a predetermined amount of the wash cycle icons 250 within the series may be visibly displayed on the display portion 200 at any time. For example, as shown in FIG. 2, only five wash cycle icons 250 are displayed (e.g., at least partially displayed) on the display portion 200 concurrently, while one or more of the other wash cycles are also available for selection. However, the one or more of the other wash cycle icons 250 are not visibly displayed on the display portion 200. One skilled in the art will appreciate, though, that this exemplary configuration is not intended to limit the present disclosure. In this regard, any number of wash cycle icons 250 may be concurrently displayed on the display portion 200 at any time, including all available wash cycle icons 250 in the series.

In accordance with one aspect of this disclosure, the selected wash cycle icon 250 is centered and enlarged within the series of wash cycle icons (e.g., within the series of wash cycle icons that are being simultaneously displayed on the display portion 200 with the selected wash cycle icon). For example and as shown in FIGS. 1-4, the selected wash cycle icon 250, which is centered and enlarged, is displayed on the display portion 200 with at least a portion of at least one other of the wash cycle icons. More specifically, the selected wash cycle icon 250, which is centered and enlarged, is displayed on the display portion 200 with at least a portion of a plurality of the other wash cycle icons. In addition, each of the one or more wash cycle icons 250 that are adjacent to the selected wash cycle icon 250, which is centered and enlarged, may be only partially displayed (e.g., may be truncated) on the display portion 200, to make room for the enlargement of the selected wash cycle icon 250. In accordance with one aspect, each of the plurality of the wash cycle icons 250 that are concurrently displayed on the display portion 200 with the selected wash cycle icon 250, which is centered and enlarged, may be selected via user touch interaction with the touchscreen user interface 150, to change the wash cycle icon that is presently selected (i.e., centered and enlarged).

In instances where only a predetermined amount of wash cycle icons 250 are displayed concurrently (i.e., one or more of the other wash cycles are available for selection, but are not displayed), the series of wash cycle icons 250 may be configured to be scrollable with respect to the display portion 200 such that the user can scroll through the wash cycle icons 250 to view the non-displayed other wash cycle icons 250. That is, the series of wash cycle icons 250 may be laterally (rows) or vertically (columns) scrollable, in either direction, to allow the user to view or otherwise scroll among the series of wash cycle icons 250. In this regard, the series of wash cycle icons 250 may be scrollable in either direction. For example, as illustrated in FIGS. 2 and 3, the Normal wash cycle icon 256 is moved across the screen in one scrolling direction as the series of wash cycle icons 250 is scrolled, and an Active wear wash cycle icon 252 disappears from the display portion 200, while a Heavy Duty wash cycle icon 254 visibly appears on the display portion 200.

The scrolling action of the series of wash cycle icons 250 can occur in a number of ways via user touch interaction with the display portion 200. According to one aspect, the series of wash cycle icons 250 is scrolled in response to/as part of the previously discussed centering of the selected one of the wash cycle icons 250. For example and referring to FIGS. 2 and 3, while the Normal wash cycle icon 256 is the currently selected (i.e., centered and enlarged) wash cycle icon 250, the user may select, via user touch interaction with the display portion 200, the Colors wash cycle icon 258. In response, the Colors wash cycle icon 258 becomes the currently selected (i.e., centered and enlarged) wash cycle icon 250, thereby causing the series of wash cycle icons 250 to be scrolled from the configuration shown in FIG. 2 to the configuration shown in FIG. 3. Such scrolling interaction can occur in either direction of the series.

In other instances, the user may scroll the series of wash cycle icons 250 by use of a swiping/brushing motion across the display portion 200 in either scrolling direction. That is, for example, the user may touch the display portion 200 with a finger, in the proximity of the series of wash cycle icons 250, and then drag/swipe/brush the finger across the display portion 200 in a scrolling direction to thereby cause the series of wash cycle icons 250 to scroll in the selected scrolling direction. In some instances, the intensity of the swiping/brushing motion by the user in the scrolling direction may determine or otherwise affect the extent to which the series of wash cycle icons 250 is scrolled. In this regard, a quick drag/swipe/brush motion across the display portion 200 in the scrolling direction may effect more scrolling action of the wash cycle icons 250 than a light or slow drag/swipe/brush motion across the display portion 200 in the scrolling direction. In addition, the previously selected (i.e., centered and enlarged) wash cycle icon 250 may be reduced in size in response to the drag/swipe/brush motion across the display portion 200 in the scrolling direction, such that all of the wash cycle icons 250 within the series are approximately the same size (e.g., such that none of the wash cycle icons 250 is selected (i.e., centered and enlarged)), as shown in FIGS. 5 and 6. In some instances and as shown in FIG. 5, the texts (i.e., strings of alphanumeric characters) of or otherwise associated with the wash cycle icons 250 may be removed from (e.g., temporarily may not be displayed upon) the display portion 200 during the scrolling of the series of wash cycle icons 250 that occurs in response to the drag/swipe/brush motion across the display portion 200 in the scrolling direction. Furthermore, upon stopping of the scrolling motion, the wash cycle icon 250 closest to the center of the display portion 200 may automatically/defaultly become the currently selected wash cycle icon 250, such that it is centered and enlarged so as to indicate that it is the selected wash cycle icon 250, even though this selected wash cycle icon may be characterized in some circumstances as not having been intentionally selected by the user.

Further, according to some aspects, predetermined user actuation upon the display portion 200 may cause a scroll bar icon 300 to be displayed, as shown in FIG. 6. For example, the scroll bar icon 300 may be displayed in response to a user touching the display portion 200/one of the non-selected (i.e., not enlarged and centered) wash cycle icons 250 for an extended period, such that the scroll bar icon 300 is displayed instead of the touched wash cycle icon 250 being selected (e.g., instead of the touched wash cycle icon 250 being centered and enlarged). In addition (e.g., in response to the user touching the display portion 200/one of the non-selected wash cycle icons 250 for an extended period), the previously selected (i.e., centered and enlarged) wash cycle icon 250 may be reduced in size such that all of the wash cycle icons 250 within the series are unselected and approximately the same size on the display portion 200. In other instances, the scroll bar icon 300 may be displayed in response to a user touching the display portion 200/one of the non-selected wash cycle icons 250, and then dragging (e.g., via a drag/swipe/brush motion across the display portion 200) the one of the non-selected wash cycle icons 250 in either scrolling direction, such as for scrolling among the series of wash cycle icons 250.

In some instances, the scroll bar icon 300 may be displayed adjacent to the series of wash cycle icons 250 displayed on the display portion 200. The scroll bar icon 300 may be shown/displayed on the display portion 200 as including a slider icon 302 movable within a slider track 304 that extends in the first and second scrolling directions. The scroll bar icon 300 is configured such that the slider icon 302 may be moved along the slider track 304 via user touch interaction with the touchscreen user interface, such as by the user touching the display portion 200/the slider icon 302, and then dragging (e.g., via a drag/swipe/brush motion across the display portion 200) the slider icon in either direction along the slider track 304. In response to the movement of the slider icon 302 along the slider track 304, the series of wash cycle icons 250 is scrolled in the respective one of the first and second scrolling directions. Furthermore, if a selection of one of the wash cycle icons 250 is not made by the user after a predetermined duration after the scroll bar icon 300 is displayed, then the wash cycle icon 250 closest to the center of the display portion 200 may be centered and enlarged so as to indentify that particular wash cycle icon as being the selected wash cycle icon 250, even though it was not actually selected by the user. That is, upon stopping of the scrolling motion, the wash cycle icon 250 closest to the center of the display portion 200 may automatically/defaultly become the currently selected wash cycle icon 250, such that it is centered and enlarged so as to indicate that it the selected wash cycle icon 250, even though this selected wash cycle icon may be characterized in some circumstances as not having been intentionally selected by the user.

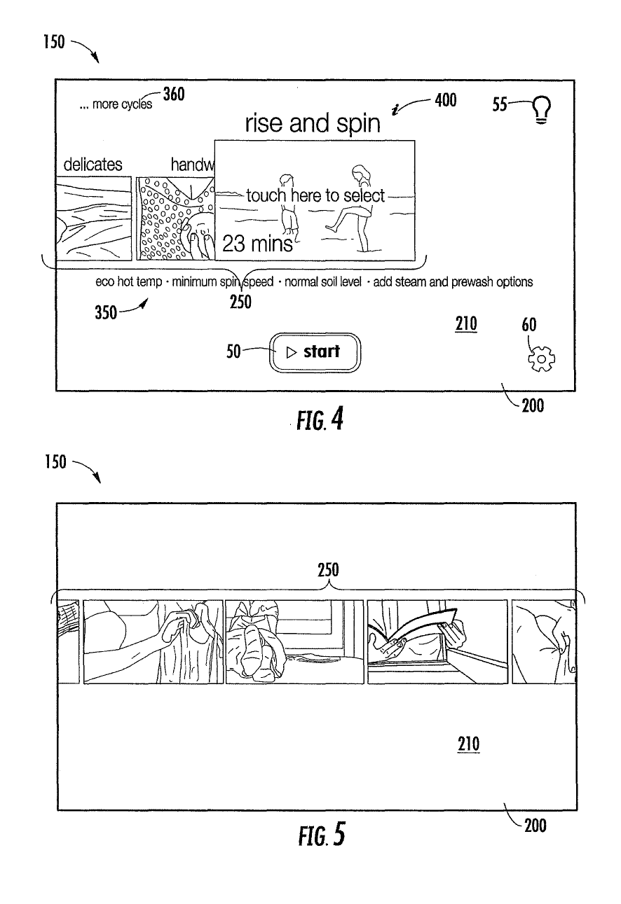

In some aspects of the present disclosure, the series of wash cycle icons 250 may be continuously or infinitely scrollable in either scrolling direction through user interaction, such as by swiping/brushing the series of wash cycle icons 250 in a single scrolling direction. Referring to FIG. 4, in other instances, the series of wash cycle icons 250 may be scrollable only to the respective ends of the series such that, by swiping/brushing the series of wash cycle icons 250 in a single scrolling direction, the scrolling of the series of wash cycle icons 250 is stopped at the last wash cycle icon 250 of the series in the particular scrolling direction, wherein the wash cycle icons 250 cannot be scrolled any further in that particular scrolling direction.

According to some aspects of the present disclosure, an initial selection of one of the wash cycle icons 250 displayed on the display portion 200 causes primary parameter icons 350 (e.g., cycle parameter indicia), which are associated with the selected wash cycle, to be displayed on the display portion 200, as shown in FIGS. 2-4. In some instances, the series of wash cycles may include a designated default wash cycle such as, for example, a “Casual” wash cycle. In those instances, an initial display on the display portion 200 may include the default “Casual” wash cycle icon that is highlighted or otherwise distinguished (e.g., the Casual wash cycle icon may be centered and enlarged on the display portion), with the primary parameter icons 350 being displayed with, proximate and/or adjacent thereto on the display portion 200. Alternatively, the designated default wash cycle may be any other suitable wash cycle such as, but not limited to, the Normal wash cycle, such that the initial display on the display portion 200 includes the centered and enlarged Normal wash cycle icon 256 on the display portion 200, with the primary parameter icons 350 being displayed with, proximate and/or adjacent thereto on the display portion 200.

The primary parameter icons 350 may be indicative of parameters common to all of the wash cycles, such as, for example, water temperature, the spin rate or speed, the soil level of the laundry, options (e.g., steam and prewash options), and cycle time (e.g., the total duration time of the cycle). In some instances, one or more of the primary parameter icons 350 may be displayed adjacent to the series of wash cycle icons 250, and one or more of the primary parameter icons 350 may be displayed in any other suitable location, such as within or superposed with the graphic (e.g., photographic image) of the selected wash cycle icon 250. For example and as shown in FIGS. 2 and 3, the water temperature, spin rate or speed, soil level, and steam and prewash option icons of the primary parameter icons 350 may be displayed vertically-adjacent to a horizontal row of the selectable wash cycle icons 250. In contrast and as also shown in FIGS. 2 and 3, the cycle time icons of the primary parameter icons 350 may be displayed within or superposed with the graphic (e.g., photographic image) of the selected wash cycle icon 250.

The primary parameter icons 350 may be set to default values of each respective wash cycle such that, upon selection of a particular wash cycle by a user via the associated wash cycle icon 250, the primary parameter icons 350 reflect the default values of that particular wash cycle. For example, as shown in FIG. 2, a selection of the Normal wash cycle icon 256 causes at least some of the primary parameter icons 350 to display the default values associated therewith. For example and as shown in FIG. 2, the primary parameter icons 350 include a water temperature parameter icon that is associated with and indicates a default value of “eco hot”, a spin rate parameter icon that is associated with and indicates a default value of “minimum”, a soil level parameter icon that is associated with and indicates a default value of “normal”, an options parameter(s) icon that is associated with and indicates a default value of “add steam and prewash”, and a cycle time icon that is associated with and indicates a default value of “55 mins” for 55 minutes, or the like, when the Normal wash cycle icon 256 is selected. The default values of the primary parameter icons 350, associated with the selected wash cycle, may be indicated on the display portion 200 using textual indicia, numerical indicia, or any other suitable indicia. Further, the primary parameter icons 350 may display appropriate graphics (e.g., a thermometer for the water temperature parameter) for indicating to the user the particular parameter or value thereof associated with the primary parameter icon 350.

According to some aspects of the present disclosure, the primary parameter icons 350 may only be displayed on the display portion 200 when the associated wash cycle icon 250 is selected (e.g., centered and enlarged) on the display portion 200. In this regard, scrolling the series of wash cycle icons 250 such that the initially-selected or default wash cycle icon 250 is no longer centered and enlarged (as discussed above), in turn, causes the primary parameter icons 350 associated with the initially-selected or default wash cycle icon 250 to be removed from the display portion 200 (see, e.g., FIGS. 5 and 6).

A wide variety of variations to the primary parameter icons 350 and the values associated therewith are within the scope of this disclosure. For example and as a variation of what is shown in FIG. 2, the primary parameter icons 350 may include a water temperature parameter icon that is associated with and indicates a default value of “eco cold temp”, a soil level parameter icon that is associated with and indicates a default value of “heavy soil”, a spin rate parameter icon that is associated with and indicates a default value of “medium spin”, an options parameter(s) icon that is associated with and indicates a default value of “night quite”, and a cycle time icon that is associated with and indicates a default value of “52 min” for 52 minutes, or the like, when the Normal wash cycle icon 256 is selected.

As another example and as a variation of what is shown in FIG. 3, the primary parameter icons 350 may include a water temperature parameter icon that is associated with and indicates a default value of “eco warm temp”, a soil level parameter icon that is associated with and indicates a default value of “medium soil”, a spin rate parameter icon that is associated with and indicates a default value of “medium spin”, and a cycle time icon that is associated with and indicates a default value of “27 min” for 27 minutes, or the like, when the Colors wash cycle icon 258 is selected.

As yet another example and as a variation of what is shown in FIG. 4, a Spin Only wash cycle icon (not shown) may be positioned between the Hand Wash and Rinse and Spin wash cycle icons. Also as a variation of what is shown in FIG. 4, the primary parameter icons 350 may include a water temperature parameter icon that is associated with and indicates a default value of “cold water clean”, a spin rate parameter icon that is associated with and indicates a default value of “maximum spin”, an options parameter(s) icon that is associated with and indicates a default value of “freshwater rinse”, and a cycle time icon that is associated with and indicates a default value of “14 min” for 14 minutes, or the like, when the Rinse and Spin wash cycle icon is selected. Other variations are also within the scope of this disclosure.

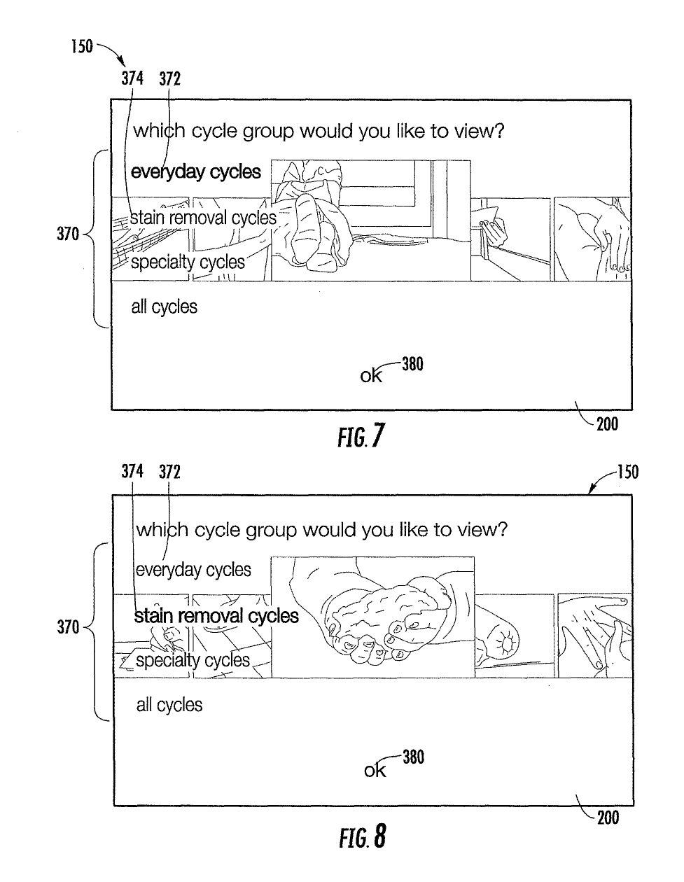

According to some aspects of this disclosure, a cycle category icon 360 may be displayed on the display portion 200, as shown in FIGS. 2-4. In response to user actuation of the cycle category icon 360, a plurality of cycle group icons 370 (FIG. 7) may be displayed on the display portion 200. In some instances, the cycle group icons 370 may be superimposed on the (dimmed) main menu display 210, such that wash cycle icons 250 are still visible on the display portion 200. The wash cycle icons 250 are typically grouped into selectable categories (e.g., favorite cycles, everyday cycles, stain removal cycles, specialty cycles and/or all cycles), with each category being associated with a respectively named, or otherwise identified, icon of the plurality of cycle group icons 370. In response to user selection of/touch interaction with one of the icons of the plurality of cycle group icons 370 (i.e., user selection of a particular group of wash cycles), the selected category of wash cycles (i.e., the wash cycle icons 250 corresponding to the selected category of wash cycles) replaces the previous category of wash cycles (i.e., the wash cycle icons 250 corresponding to the previous category of wash cycles) displayed on the display portion 200. The cycle category icon 360 may be displayed on the display portion along with the series of wash cycle icons. In some instances, the user may need to actuate an ok icon 380 displayed on the display portion 200, after selecting one of the cycle group icons 370, in order to remove the cycle group icons 370 from the display portion 200, such that the respective wash cycle icons 250 can be scrolled and/or selected.

For example, as shown in FIG. 7, the everyday cycle group icon 372 of the plurality of cycle group icons 370 is selected such that the following wash cycle icons 250 are provided in the series and displayed on the display portion 200: Bulky, Bedding, Sanitize (or Deep Clean), Heavy Duty, Whitest Whites, Colors, Cold Water Clean, Normal, Casual, Active Wear, Fast Wash, Delicates, Hand Wash, Spin Only, and Rinse And Spin. As shown in FIG. 8, when the stain removal cycles icon 374 of the plurality of cycle group icons 370 is selected, the following wash cycle icons 250 are provided in the series and displayed on the display portion 200: Adhesives, Beverages, Blood, Wax, Chocolate, Cosmetics, Dairy, Dyes, Grass, Grease, Ink, Mildew, Mud, Mustard, Nail Polish, Oil Based Paint, Water Based Paint, Perspiration, Red Wine, Rust, Shoe Polish, Tomato, and Vomit.

According to aspects of the present disclosure, there may be any number of selectable categories of wash cycles and associated icons of the plurality of cycle group icons 370. Accordingly, the present disclosure is not limited to the categories shown. Optionally, one category (e.g., an All Cycles icon of the plurality of cycle group icons 370) may allow all wash cycles (i.e., all wash cycle icons 250) to be displayed on the display portion 200. As another example, when a Specialty Cycles icon of the plurality of cycle group icons 370 is selected, the following wash cycle icons 250 are provided in the series and displayed on the display portion 200: Jeans, Sanitize, Stuffed Animals, Pet Beds, Clean Washer, Steam Prewash, Kids Wear, Fast Steam, Wool, Rugs and Mats, Cashmere, Comforter, and Silk. As another example, the plurality of cycle group icons 370 may include a Favorites icon, which is discussed in greater detail below.

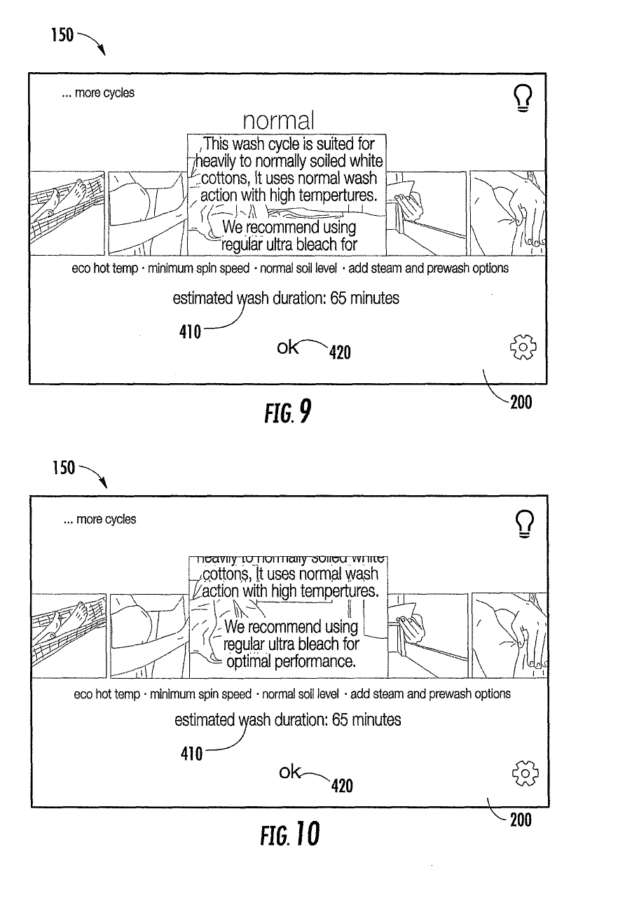

According to some aspects of the present disclosure, a selectable information icon 400 may be displayed on the display portion 200, as shown in FIGS. 2-4. In some instances, the information icon 400 may be displayed adjacent to the centered and enlarged, initially selected wash cycle icon 250. User actuation (e.g., selection via touch interaction with the respective portion of the display portion 200) of the information icon 400 may cause information, or other features (e.g., icons) associated with the wash cycle associated with the initially selected wash cycle icon 250 to be displayed on the display portion 200, as shown in FIGS. 9 and 10. In some aspects, this displayed information associated with the wash cycle associated with the initially selected wash cycle icon 250 may be in the form of an alphanumeric description that is displayed on or as part of the selected (e.g., enlarged and centered) wash cycle icon 250. For example, while the Normal wash cycle icon 256 is selected, user touch interaction with the information icon 400 may cause a description of the normal wash cycle to be displayed on the (dimmed) Normal wash cycle icon 256 on the display portion 200. In some instances, the provided description may be vertically or laterally scrollable via user touch interaction such that the complete description can be read by the user. FIGS. 9 and 10 display an example of the content of the description displayed on the display portion 200 in response to selection of the information icon 400. Other suitable descriptions may be displayed on the display portion 200 in response to selection of the information icon 400, and the descriptions may be tailored to their respectively associated wash cycles.

In addition, indicia 410 of the estimated wash cycle duration, or other suitable icons and/or information, for the selected wash cycle may be displayed on the display portion 200 in response to user selection of/touch interaction with the information icon 400. The indicia 410 of the estimated wash cycle duration for the selected wash cycle typically corresponds to the cycle time (e.g., the total duration time of the cycle) of the primary parameter icons 350. Accordingly and similarly to the above discussion of the cycle time (e.g., the total duration time of the cycle) of the primary parameter icons 350, the indicia 410 of the estimated wash cycle duration may be set to default values of each respective wash cycle. For example, as shown in FIGS. 9 and 10, the indicia 410 of the estimated wash cycle duration is “65 minutes”. However, a wide variety of variations to the indicia 410 of the estimated wash cycle duration and the values associated therewith are within the scope of this disclosure. For example and as a variation of what is shown in FIGS. 9 and 10, a default value of “52 minutes”, or the like, may be a part of or associated with the indicia 410 of the estimated wash cycle duration.

Further regarding FIGS. 9 and 10, in some instances, the user may need to actuate an ok icon 420, which is displayed on the display portion 200, in order to remove information, icons or the like, which were displayed in response to the selection of the information icon 400, from the display portion 200 such that the wash cycle icons 250 can be scrolled.

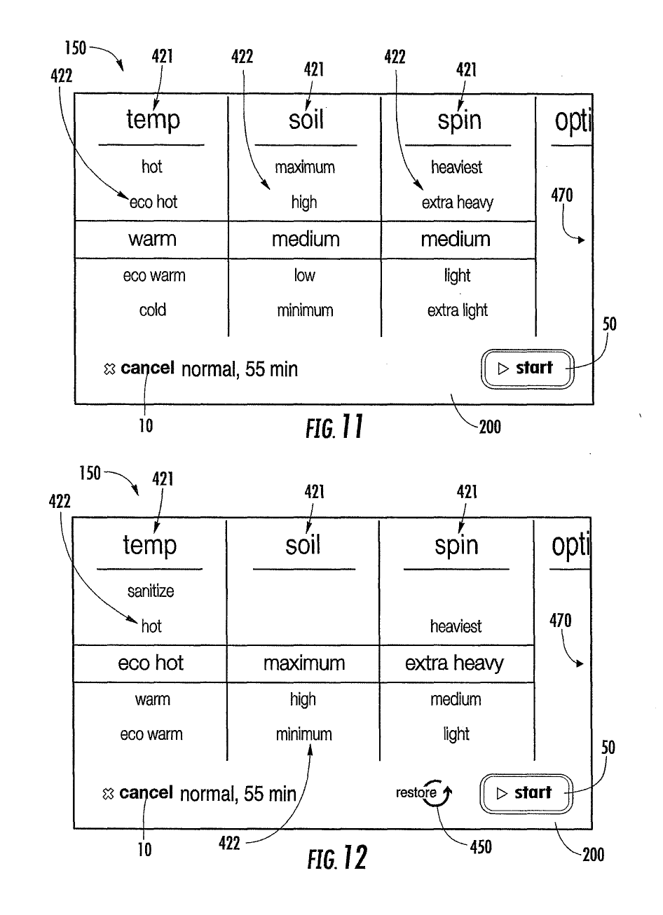

According to some aspects of the present disclosure, a subsequent selection of the currently selected wash cycle icon 250 displayed on the display portion 200 (e.g., the centered and enlarged wash cycle icons 250 shown in FIGS. 1-4) optionally causes the enlarged wash cycle icon 250 to become further enlarged (e.g., fully enlarged, so as to occupy substantially all of the display portion 200), and further causes a plurality of cycle parameter menus 421 associated with the selected wash cycle to be displayed on the display portion 200, as shown in FIGS. 11 and 12. In addition, the non-selected wash cycle icons 250 may be at least partially removed, or fully removed, from the display portion 200, as shown in FIGS. 11 and 12.

The cycle parameter menus 421 are indicative of parameters, such as, for example, water temperature, soil level of laundry, and spin cycle, associated with each respective wash cycle. That is, the cycle parameter menus 421 may include each of temp, soil and spin menus. For example, the enlarged display that includes the cycle parameter menus 421 may include a listing of the selectable values (e.g., cycle settings) associated with each cycle parameter menu in a scrollable column.

As an example, the water temperature (i.e., temp) menu of the cycle parameter menus 421 may include one or more of, or each of, the following selectable values: sanitize, hot, eco hot, warm, eco warm, and cold. In addition and/or as another example, the water temperature (i.e., temp) menu may include one or more of, or each of, the following selectable values: sanitize, hot, eco hot, warm, eco warm, cold, eco cold and cold water clean.

For example, the soil level (i.e., soil) menu of the cycle parameter menus 421 may include one or more of, or each of, the following selectable values: heaviest, extra heavy, medium, light, and extra light. In addition and/or as another example, the soil level (i.e., soil) menu may include one or more of, or each of, the following selectable values: maximum, heavy, normal, light and minimum.

As another example, the spin menu of the cycle parameter menus 421 may include one or more of, or each of, the following selectable values: maximum, high, medium, low, and minimum. Notwithstanding the foregoing and following specific examples, a wide variety of parameters and associated values (e.g., including predetermined default values as discussed below) of the cycle parameter menus 421 are within the scope of this disclosure.

A desired value for each cycle parameter menu 421 may be selectable by touch interaction with the desired value/the respective portion of the display portion 200 of the touchscreen user interface 150. According to some aspects, a desired value for each cycle parameter menu 421 may be selectable by way of scrolling through the associated list of selectable values. In some instances, the scrolling motion of the various selectable values associated with each cycle parameter menu 421 may be similar to that of a slot machine in which value icons 422 (e.g., textual indicia) associated with the cycle parameter (e.g., the sanitize, hot, eco hot, warm, eco warm, cold values associated with the water temperature menu) appear to move vertically (e.g., rotatably move vertically) and, in some instances, move vertically off of and onto the display portion 200. In some aspects, the scrolling action may be caused by a user selecting one of the non-selected parameter values (e.g., selecting one of the value icons 422), thereby causing the selected cycle parameter value/value icon 422 to move to the center of the vertical column of the respective cycle parameter menu. In some instances, the parameters values/value icons 422 may be vertically scrollable via a swiping/brushing user touch interaction, as described previously, in a vertical direction over the value icons 422 of the cycle parameter menus 421.

The cycle parameter values/value icons 422 of the cycle parameter menus 421 may be set to predetermined default values, such that when a wash cycle is selected via the associated wash cycle icon 250 and then the cycle parameter menus are displayed for the selected wash cycle, the displayed cycle parameter menus show the default values of the cycle parameters as being selected. In some instances, the selected cycle parameter values/value icons 422 may be visually distinguished such that the user is informed of the current cycle parameter selections, as shown, for example, by a combination of underlining and overlining in FIGS. 11 and 12. The combination of the underlining and overlining in FIGS. 11 and 12 may be schematically illustrative of conventional “highlighting”, and other suitable means for visually distinguishing may be used.

Reiterating from above and stated differently, upon first causing the cycle parameter menus 421 to be displayed, the cycle parameter values may typically be set to default parameters associated with the selected wash cycle. For example, as shown in FIG. 11, the default cycle parameters associated with the normal wash cycle may include a warm water temperature, a medium soil level, and a medium spin cycle, wherein these default parameter values/value icons 422 are visually distinguished. Alternatively, the default cycle parameters associated with the normal wash cycle and visually distinguished in the cycle parameter menus 421 may be an eco cold water temperature, a heavy soil level, and a medium spin cycle, although any other suitable default cycle parameters may be specified. The default parameter values/value icons 422 may be visually distinguished by being centered in the respective cycle parameter menus 421/vertical columns and highlighted to indicate their current selection. For example, this highlighting may be by way of a substantially single, central and horizontally extending region that is highlighted or otherwise distinguished.

As shown, for example, by the contrast between FIGS. 12 and 11, the cycle parameters values associated with the normal wash cycle may be changed via scrolling of the value icons 422 associated with the cycle parameters, such as, for example, to a eco hot water temperature, a maximum soil level, and an extra heavy spin cycle. In addition, changing any one of the cycle parameters may cause a restore icon 450 to be displayed. The restore icon 450 may be selected by a user in order to automatically return the parameter cycle settings of the selected wash cycle to their default values/default parameter cycle settings (e.g., returning to the values visually distinguished in FIG. 11).

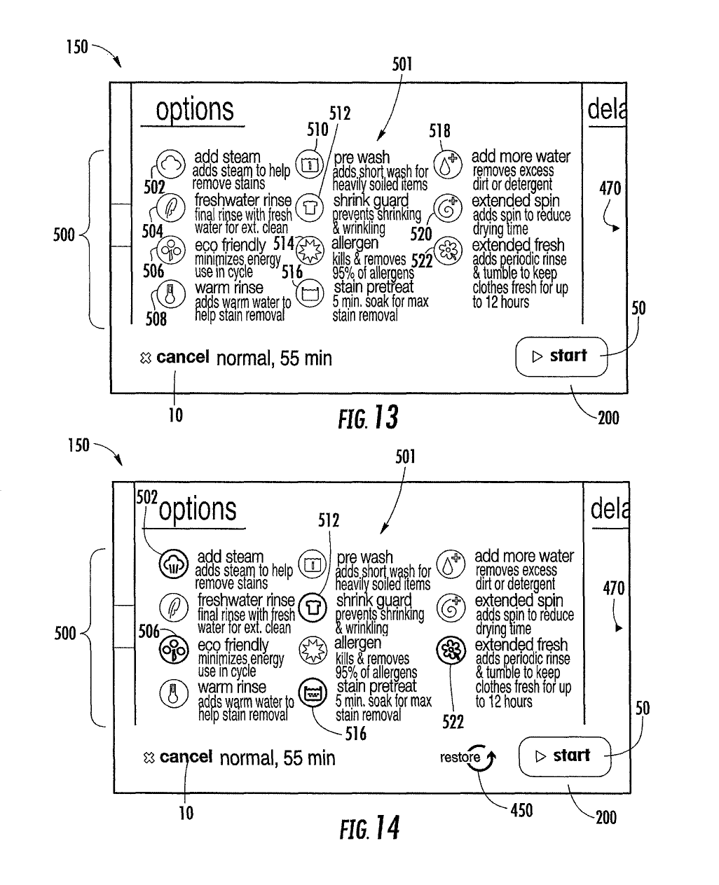

Furthermore, the plurality of cycle parameter menus 421 shown in FIGS. 11 and 12 may be laterally scrollable upon (e.g., off of) the display portion 200 so that the display portion 200 displays (e.g., more fully displays) one or more other cycle parameter menus. The plurality of cycle parameter menus 421 may be laterally scrolled relative to the display portion 200 in response to user selection of/touch interaction with an actuatable directional icon 470, or in response to any other suitable user interaction with the touchscreen user interface 150. More specifically, an options menu 501, which is shown in FIGS. 13 and 14 and has a collection of selectable option icons 500 associated with the selected wash cycle, may be scrolled to in response to user selection of/touch interaction with the actuatable directional icon 470 shown in FIGS. 11 and 12. Each option icon 500 corresponds to a respective cycle option that may be implemented for (e.g., incorporated into) one or more of the wash cycle(s)

Referring to FIGS. 13 and 14, the selectable option icons 500 included in the options menu 501 may include, for example, an add steam option icon 502, a freshwater rinse option icon 504, an eco friendly option icon 506, a warm rinse option icon 508, a pre wash option icon 510, a shrink guard option icon 512, an allergen option icon 514, a stain pretreat option icon 516, an add more water option icon 518, an extended spin option icon 520, and an extended fresh option icon 522. The options icons 500 and their associated descriptions shown in FIGS. 13 and 14 are provided as examples; other icons, differently configured icons and/or different descriptions associated with the options icons are within the scope of this disclosure. As examples, the freshwater rinse option icon 504 may include an image indicative of spraying water rather than a feather, a warm rinse option icon may be included, a “night quite” option icon may be included, the add more water option icon 518 may include an image indicative of water flowing from a spigot and/or other variations are within the scope of this disclosure. In some instances, the collection of selectable option icons 500 may be superimposed on the enlarged and dimmed image associated with the selected wash cycle icon 250, such that the enlarged image forms a background on the display portion 200.

User selection of/touch interaction with one of the option icons 500 may cause the selected option icon 500 to be visually-distinguished, highlighted or otherwise visually indicated as selected when the user interacts therewith, as shown in FIGS. 13 and 14. For example, as shown in FIG. 14, the add steam option icon 502, the eco friendly option icon 506, the shrink guard option icon 512, the stain pretreat option icon 516, and the extended fresh option icon 522 are indicated as selected via highlighting of the graphic associated therewith, although any other suitable means for distinguishing may be used.

Furthermore, according to some aspects, the option icon (e.g., the add steam option icon 502, the freshwater rinse option icon 504, the eco friendly option icon 506, the warm rinse option icon 508, the pre wash option icon 510, the shrink guard option icon 512, the allergen option icon 514, the stain pretreat option icon 516, the add more water option icon 518, the extended spin option icon 520, and the extended fresh option icon 522) for any option not recommended or otherwise unavailable for a particular wash cycle may be rendered non-selectable in the collection of option icons 500. For example, the non-selectable options may be indicated by a “graying-out” of the textual/graphical indicia associated with the non-selectable option icons of the collection of selectable option icons 500. In this regard, the visual contrast between the textual/graphical indicia of the non-selectable option icons and the enlarged image may be decreased such that the textual/graphical indicia is only dimly or faintly visible to the user. However, any suitable visual indicia or indication may be provided to indicate that an option is not recommended or available for use. In some instances, an aural indicia (e.g., a beeping sound) may be provided to the user when interacting with a non-selectable option to indicate that the option is non-selectable. In addition, selecting and/or changing any one of the option icons 500 may cause the restore icon 450 to be displayed. The restore icon 450 may be selected by the user for returning the selected wash cycle to its default options settings.

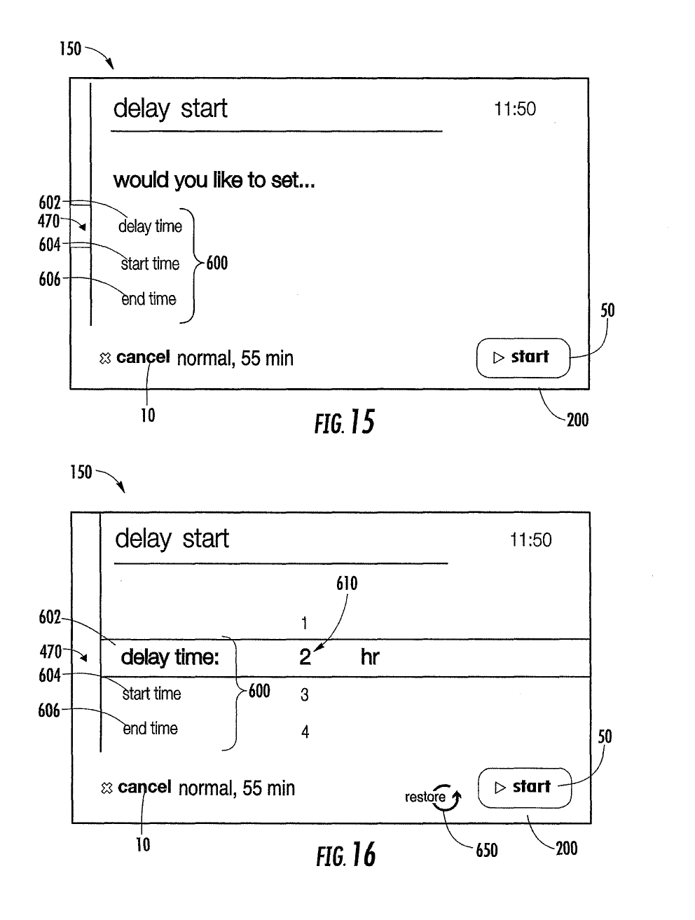

The options menu 501 shown in FIGS. 13 and 14 may be laterally scrollable upon (e.g., off of) the display portion 200 so that the display portion 200 displays (e.g., more fully displays) one or more of the cycle parameter menus 421. The options menu 501 may be laterally scrolled relative to the display portion 200 in response to user selection of/touch interaction with the actuatable directional icon 470 of FIGS. 13 and 14, or in response to any other suitable user interaction with the touchscreen user interface 150. More specifically, a delay start menu, which is shown in FIGS. 15 and 16, may be scrolled to in response to user selection of/touch interaction with the actuatable directional icon 470.

The delay start menu shown in FIGS. 15 and 16 includes a collection of selectable delay start option icons 600 associated with the selected wash cycle. The collection of selectable delay start option icons 600 may be superimposed on the enlarged, dimmed image associated with the selected wash cycle icon 250, such that the enlarged, dimmed image forms a background on the display portion 200. For example, the collection of selectable delay start option icons 600 may include, for example, a delay time icon 602, a start time icon 604, and an end time icon 606. The delay start option icons 600 can be selected by a user to increase or decrease a delay or otherwise indicate a time to be used in the implementation of the selected wash cycle.

As shown in FIG. 16, selection of one of the delay start option icons 600 may cause a series of selectable value icons 610 (e.g., value indicia) to be displayed adjacent to the delay start option icons 600. User selection of/touch interaction with one of the delay start option icons 600 may cause the selected delay start option icon 600 to be visually-distinguished, highlighted or otherwise visually indicated as having been selected. For example, this highlighting may be by way of a substantially single, central and horizontally extending region that is highlighted or otherwise distinguished, and to which the selected delay start option icon 600 is moved, as shown in FIG. 16. In addition, the text or other aspects of the selected delay start option icons 600 may be enlarged relative to the delay start option icons 600 that have not been selected.

One of the time value icons 610 may be selected by a user touching the one of the time value icons 610 on the display portion 200. The one of the value icon 610 selected by the user may also be visually-distinguished, highlighted or otherwise visually indicated as selected. For example, this highlighting may be by way of the substantially single, central and horizontally extending region that is highlighted or otherwise distinguished, and to which the selected value icon 610 is moved (e.g., automatically scrolled). In addition, one of the time value icons 610 may be selected by scrolling (e.g., by the user touching the display portion 200/the series of value icons 610 and performing a swiping/brushing motion across the display portion 200) the series of value icons 610 relative to the substantially single, central and horizontally extending region that is highlighted or otherwise distinguished. In addition, the text or other aspects of the selected value icon 610 may be enlarged relative to the time value icons 610 that have not been selected. For example, as shown in FIG. 16, the delay time icon 602 and a two hour value icon 610 are indicated as selected via highlighting of the alphanumeric indicia associated therewith. In addition, changing any one of the delay start option icons 600 may cause a reset icon 650 to be displayed on the display portion 200. The reset icon 650 may be selected by a user to cause the delay start settings for the selected wash cycle to return to the default delay start settings.

When a time is selected or otherwise indicated or associated with one of the time value icons 610 as discussed above, the controller device of the appliance may calculate one or more of, or each of, the associated start time and the associated end time. Although not shown in FIG. 16, and as an example with regard the tabular arrangement of FIG. 16, the calculated time(s) and associated explanative text may be displayed (e.g., in hours and minutes, in accordance with the 12-hour or 24-hour clock convention in the local time in which the laundry appliance is located) in a right-hand column of the delay start screen, such as below the current local time that is displayed. For example, the current local time may be displayed in the top right corner of the delay start screen, as shown in FIGS. 15 and 16.

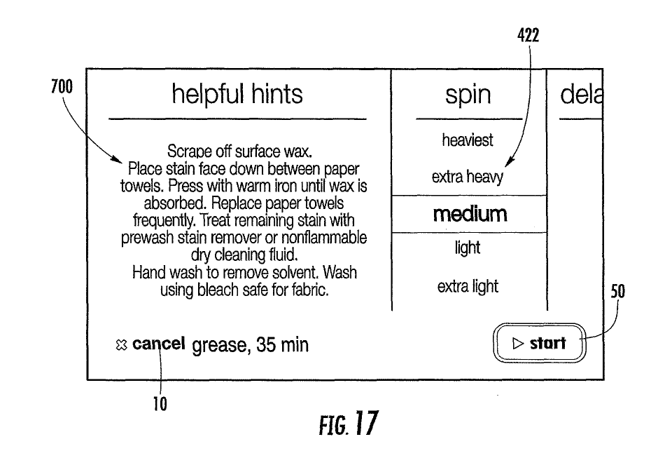

Reiterating from above, a subsequent selection of the currently selected wash cycle icon 250 displayed on the display portion 200 (e.g., the centered and enlarged wash cycle icons 250 shown in FIGS. 1-4) may cause the enlarged wash cycle icon 250 to become further enlarged, and may further cause one or more of the plurality of cycle parameter menus 421 associated with the selected wash cycle to be displayed on the display portion 200, as shown in FIGS. 11 and 12. In addition, or alternatively, and as may be understood with reference to FIG. 17, other information (e.g., an alphanumeric explanation/description 700) associated with the selected wash cycle may be displayed on the display portion 200 in a column adjacent to the left-most one of the cycle parameter menus 421. The alphanumeric explanation/description 700 may provide information (e.g., user instructions) for assisting with the selected wash cycle. For example, as shown in FIG. 17, a subsequent selection of the centered and enlarged Grease wash cycle icon after an initial selection of the grease wash cycle icon (not shown) causes the alphanumeric explanation/description 700 associated with the grease wash cycle to be displayed on the display portion 200. In some instances, the alphanumeric explanation/description 700 may be scrollable via user touch interaction. FIG. 17 displays an example of the alphanumeric explanation/description 700. Other suitable alphanumeric explanation/description 700 may be displayed on the display portion 200, and the alphanumeric explanation/descriptions 700 are typically tailored to their respectively associated wash cycles.

According to some aspects, the wash cycle start icon 50 and/or a cancel icon 10 may be displayed simultaneously with each of the menus shown in FIGS. 11-16 and the explanation/description 700 shown in FIG. 17. The user may select the cancel icon 10 of any one of FIGS. 11-17 to return to the main menu display 210. On the other hand, the user may select the start icon 50 of any one of FIGS. 11-17 to initiate the selected wash cycle. Similarly, the user may select the cycle start icon 50 from the main menu display 210, to initiate the selected wash cycle. For example, regarding the illustration of FIG. 2, user selection of the cycle start icon 50 would cause the normal wash cycle to be actuated since the Normal wash cycle icon 256 is selected (i.e., centered and enlarged).

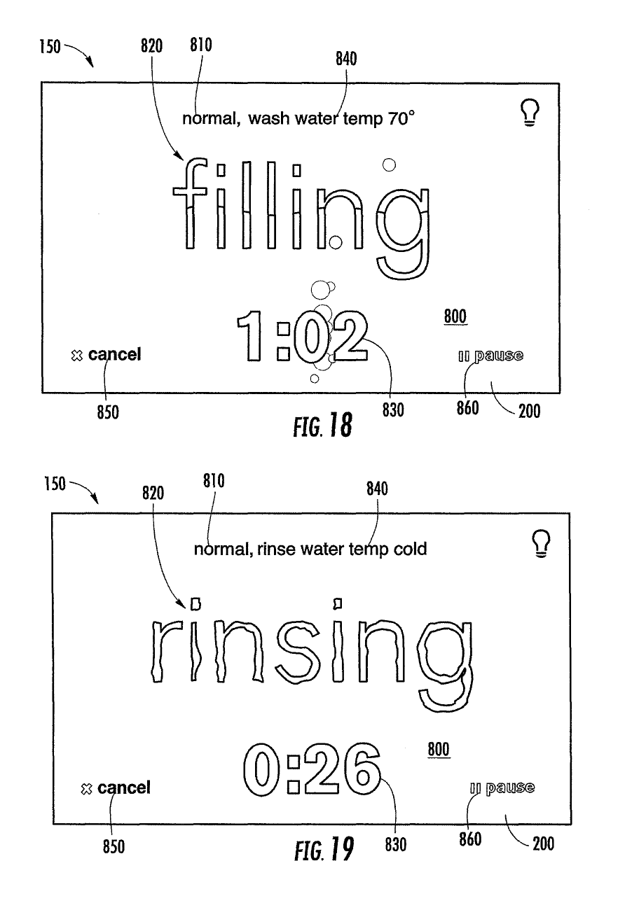

Upon initiation of the selected wash cycle via user selection of/touch interaction with the cycle start icon 50, a wash cycle status display 800 may be displayed on the display portion 200, as shown in FIGS. 18 and 19. In some instances, various wash cycle status indicators (e.g., indicia) may be displayed on the wash cycle status display 800. For example, the wash cycle status indicators may include an indicia of the selected wash cycle 810, animation 820 indicative of the wash cycle segment (e.g., fill, wash, rinse, spin, etc.) being performed, a wash cycle countdown timer 830 and/or a primary parameter icon 840 (e.g., cycle parameter indicia). In some instances, the wash cycle status indicators may be superimposed on the enlarged image of the wash cycle icon 250 associated with the implemented wash cycle.

In accordance with one aspect of this disclosure, the optional animation 820 may be full motion computer graphics, and/or alternatively recorded video, indicative of the wash cycle segment (e.g., fill, wash, rinse, spin, etc.) being performed, so that there are a plurality of animations respectively and uniquely indicative of the plurality of cycle segments. For example, as partially shown in FIG. 18 and generally described, during the fill cycle segment of the wash cycle, the animation 820 may comprise the word “filling” with bubbles passing upwardly thereby, with the letters of the word “filling” gyrating vertically, and an upwardly moving water level may be repeatedly animated upon the letters of “filling”. As another example, during the wash cycle segment of the wash cycle, the animation 820 may comprise the word “washing” with bubbles passing upwardly thereby, with the letters of the word “washing” being separately increased and decreased in size, and the letters of the word “washing” being separately alternately dimmed and/or highlighted. In another aspect of this disclosure, as partially shown in FIG. 19 and generally described, during the rinse cycle segment of the wash cycle, the animation 820 may comprise the word “rinsing” with bubbles passing upwardly thereby, and the letters of “rinsing” may be separately “wiggled” and alternately dimmed and/or highlighted. In another aspect, during the drain cycle segment of the wash cycle, the animation 820 may comprise the word “draining” with bubbles passing downwardly thereby, with the letters of the word “draining” gyrating vertically, and a downwardly moving water level may be repeatedly animated upon the letters of “draining”. In another aspect, during the spin cycle segment of the wash cycle, the animation 820 may comprise the word “spinning” with bubbles rotating therearound, and with the letters of the word “spinning” periodically separately spinning around. Similarly, during the finish cycle segment of the wash cycle, the animation 820 may comprise the word “finishing” with bubbles rotating therearound, and with the letters of the word “finishing” periodically separately spinning around. In another aspect, when the wash cycle is complete, the animation 820 may comprise the word “complete”, with the letters thereof somewhat serially appearing bright, fading and disappearing repeatedly. A variety of other animations are within the scope of this disclosure.

In accordance with one aspect of this disclosure, the primary parameter icon 840 includes indicia and/or graphics indicative of a relevant parameter of the wash cycle being implemented, so that there are a plurality of primary parameter icons 840 respectively and uniquely indicative of a plurality of parameters. Examples of the primary parameter icons 840 follow: “wash water temp 70° ” (see, e.g., FIG. 18); “rinse water temp cold” (see, e.g., FIG. 18); “1300 rpm spin speed”; and “your laundry is clean door is unlocked”. A variety of other primary parameter icon are within the scope of this disclosure.

The wash cycle status display 800 displayed on the display portion 200, as shown for example in FIGS. 18 and 19, may also include a selectable cancel icon 850 displayed for selection by the user, and user selection of/touch interaction with the cancel icon 850 causes cancellation of the implemented wash cycle. In addition, a selectable pause/stop icon 860 may be displayed on the wash cycle status display 800, and user selection of/touch interaction with the pause/stop icon 860 causes pausing or otherwise stops progress of the implemented wash cycle.

The pause/stop icon 860 may be actuated by the user in instances, for example, where the user wishes to add an article of laundry to the laundry appliance after a cycle has been initiated. In such instances, actuation of the pause/stop icon 860 causes the laundry appliance to halt the ongoing cycle and to configure the laundry appliance so as to allow the user to open the door assembly to add the article of laundry (i.e., for a washer, any water within the tub portion is first drained before the user is allowed to open the door assembly). At least for a washing machine, in response to the pause/stop icon 860 is actuated, the primary parameter icon 840 or another feature of the laundry appliance, such as another feature of the touchscreen user interface 150, indicates to the user (e.g., indicates on the display portion 200), for example, that “the door is unlocking, please wait”, followed by “door is unlocked”. In this regard, a variety of indications are within the scope of this disclosure.

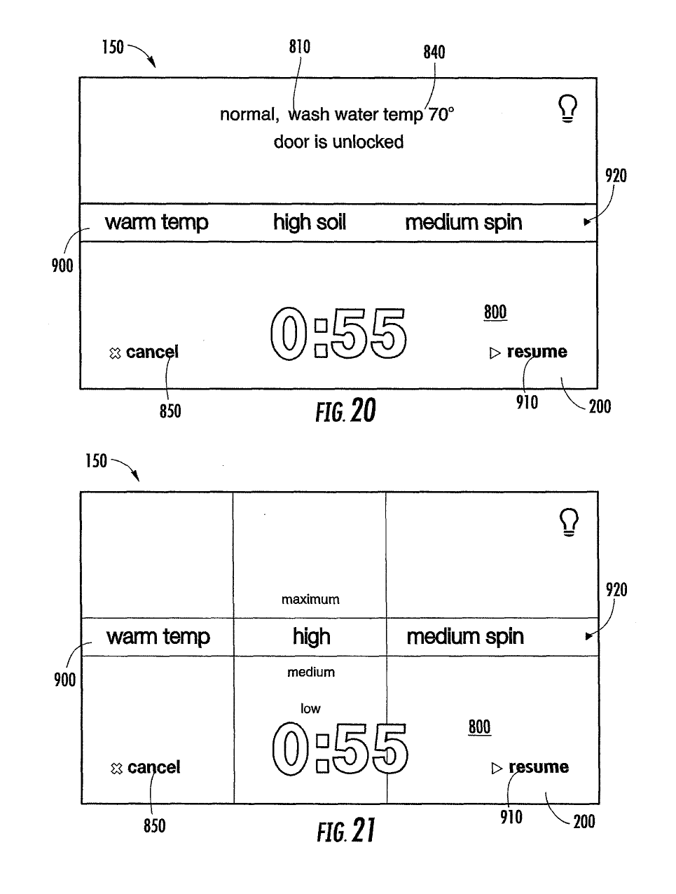

As shown in FIGS. 20 and 21, in response to user selection of/touch interaction with the pause/stop icon 860, a pause display that includes a cycle parameter band 900 may appear on the display portion 200 to indicate the currently selected cycle parameters. If the user wishes to simply add the article of laundry, the user does so and may actuate a resume icon 910 of the pause display. Upon re-starting the selected wash cycle, the interrupted cycle may continue (i.e., time-wise) from the point at which it was interrupted by the user. In other instances, instead of adding an article of laundry, the user may actuate a cancel icon 850 of the pause display that is displayed on the display portion 200 with the cycle parameter band 900. Actuation of the cancel icon 850 causes the selected wash cycle to be cancelled, and the display portion 200 returns to a display of the main menu display 210.

The cycle parameter band 900 includes primary parameter icons indicative of at least some of the values and/or settings of the primary parameters of the wash cycle that has been paused in response to user selection of/touch interaction with the pause/stop icon 860. Each of the primary parameter icons (e.g., cycle parameter indicia) included in the cycle parameter band 900 may be actuated via user touch interaction to display other values or settings of the cycle parameters that are available for being selected and used in the presently selected, and paused, wash cycle. For example, the other values or settings of the cycle parameters that are available for being selected may be displayed by way of menus, or the like, and/or they may be provided in scrollable configurations. As a more specific example, the values or settings of the cycle parameters that are available for being selected may be displayed and selected in a manner similar to that which was discussed above with reference to FIGS. 11 and 12. By way of the cycle parameter band 900, the user may select a different value or setting of a cycle parameter to be implemented in the remainder of the presently selected wash cycle upon resumption of the wash cycle.

For example, as shown in FIG. 20, upon pausing the normal wash cycle, the display portion 200 displays the cycle parameter band 900, which includes warm temperature, high soil, and medium spin cycle icons that identify to the user that the warm temperature, high soil, and medium spin cycle parameters are currently indicated for use in the wash cycle. The user may select any one of the warm temperature, high soil, and medium spin cycle icons. In response to user selection of any one of the warm temperature, high soil, and medium spin cycle icons, a corresponding cycle parameter menu is displayed for allowing the user to select a different value or setting for the corresponding cycle parameter. For example, the cycle parameter menus displayed in response to selection of the icons of the cycle parameter band 900 may be substantially like the respective cycle parameter menus 421 of FIGS. 11 and 12. A desired value for each cycle parameter menu may be selectable by touch interaction with the desired value/the respective portion of the display portion 200 of the touchscreen user interface 150 and/or by way of any suitable scrolling, or the like.

For example, in response to user selection of high soil level icon in FIG. 20, a soil level menu is displayed as shown in FIG. 21. In one example, soil level menu is displayed such that a column of various values associated with the soil level cycle parameter is shown, wherein the user may change the value associated with the soil level cycle parameter by scrolling among and selecting any one of the values or settings. After making any changes, or no changes, via the cycle parameter band 900, the user may select the resume icon 910 to continue operation of the wash cycle, implementing any changes made to the cycle parameters. The cancel icon 850 may be actuated to remove (e.g., substantially remove) the cycle parameter band 900 from the display portion 200 and thereafter present the user with, for example, a display (not shown) for confirming cancellation of the presently paused wash cycle or allowing the user to go back to the display that includes the cycle parameter band 900.

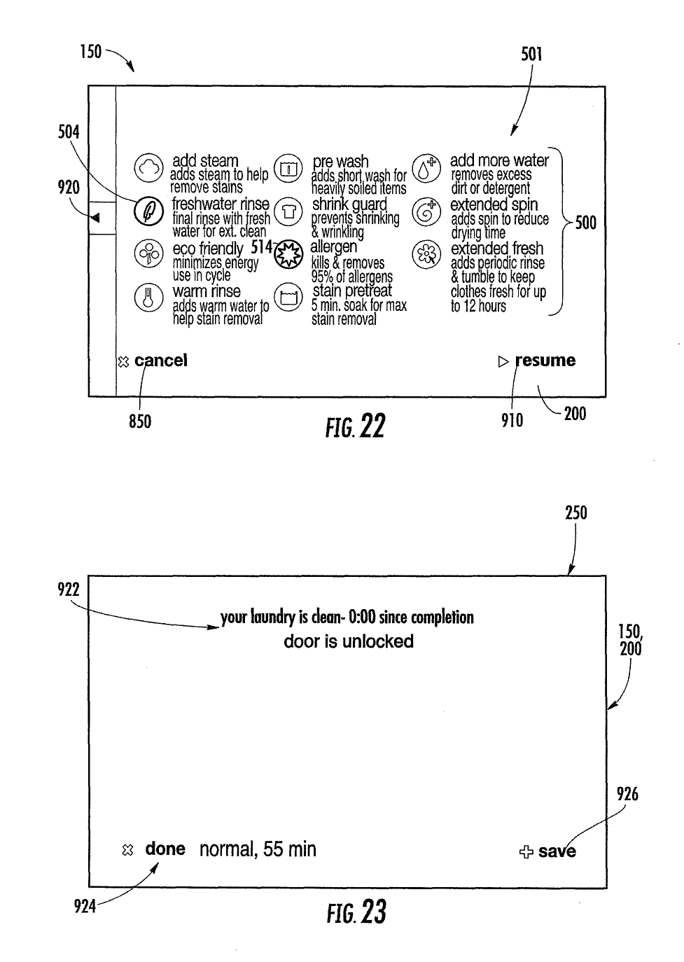

In addition, a directional icon 920 may be displayed on the cycle parameter band 900/display portion 200. User selection of the directional icon 920 results in scrolling to further options available to the user while the implemented wash cycle is paused. In response to actuation of the directional icon 920, the display portion 200 is scrolled to display the respective options menu 501 that includes the respective collection of option icons 500, as shown in FIG. 22. Aspects of the option icons 500 and options menu 501 were also discussed above with reference to FIGS. 13 and 14. From the options menu 501 shown in FIG. 22, the user may select/de-select, by way of user interaction with the respective option icons, one or more options to be implemented/de-implemented in the paused wash cycle upon resumption thereof.

After making any changes, or no changes, via the options menu 501/option icons 500, the user may select any one of the directional icon 920, the resume icon 910, or the cancel icon 850 shown in FIG. 22. In response to user selection of the directional icon 920 in FIG. 22, the display portion 200 is scrolled to display the cycle parameter band 900 discussed above with reference to FIGS. 20 and 21. On the other hand, the cancel icon 850 shown in FIG. 22 may be selected by the user to remove the options menu 501/option icons 500 from the display portion 200 and thereafter present the user with, for example, a display (not shown) for confirming cancellation of the presently paused wash cycle or allowing the user to go back to the display that includes the options menu 501/option icons 500. In response to user selection of the resume icon 910 in FIG. 22, operation of the wash cycle is continued, implementing any changes made to the cycle parameters. In accordance with the example shown in FIG. 22, upon recommencement of the wash cycle via actuation of the resume icon 910, the freshwater rinse option (the freshwater rinse option icon 504 being shown as visually distinguished) and the allergen option (the allergen option icon 514 being shown as visually distinguished) would be implemented during the wash cycle due to the selection thereof.

Referring back to FIGS. 18 and 19, the cycle parameter band 900 (FIG. 20), and then the options menu 501/option icons 500 (FIG. 22) via actuation of the directional icon 920, may be displayed in response to user selection of/touch interaction with any of the primary parameter icons 840 (see, e.g., FIGS. 18 and 19) that are displayed during implementation of a wash cycle. However, typically the values, settings and/or options respectively associated with the thusly accessed cycle parameter band 900 and options menu 501 are not initially available for selection/change. The values, settings and/or options respectively associated with the thusly accessed cycle parameter band 900 and options menu 501 may become available for selection/change in response to actuation of a selectable pause/stop icon 860, which is displayed concurrently with the cycle parameter band 900 and options menu 501 when they are accessed via the primary parameter icons 840.

As shown in FIG. 23 and in accordance with one aspect of this disclosure, in response to completion of a wash cycle, the display portion 200 of the touchscreen user interface 150 continues to display the enlarged wash cycle icon 250 (e.g., fully enlarged, so as to occupy substantially all of the display portion 200) for the wash cycle just completed, and a status icon 922, a done icon 924 and optionally a save icon 926 may also be superimposed on the enlarged image of the wash cycle icon, as shown in FIG. 23. The status icon 922 may indicate that “your laundry is clean”, “the door is unlocked” and/or how long ago the most recently completed wash cycle was completed. The user may select the done icon 924 or save icon 926 via touch interaction with the respective portion of the display portion 200. The display portion 200 displays the main menu display 210 (e.g., see FIGS. 1-3) in response to selection of the done icon 924.

As will be discussed in greater detail below, optionally, one ore more favorite wash cycles (e.g., a new wash cycle) may be created and optionally also saved by a user of the laundry appliance. More specifically, one aspect of this disclosure is the provision of one or more methods and associated features for allowing a user of the laundry appliance to create and optionally also save favorite wash cycles. In one example discussed immediately below with reference to the save icon 926 shown in FIG. 23, a wash cycle that has been completed by the laundry appliance may be saved as a favorite wash cycle. Alternatively or in addition, a favorite wash cycle may be created and saved without having to initially have the laundry appliance complete the favorite wash cycle, as will be discussed in greater detail below.

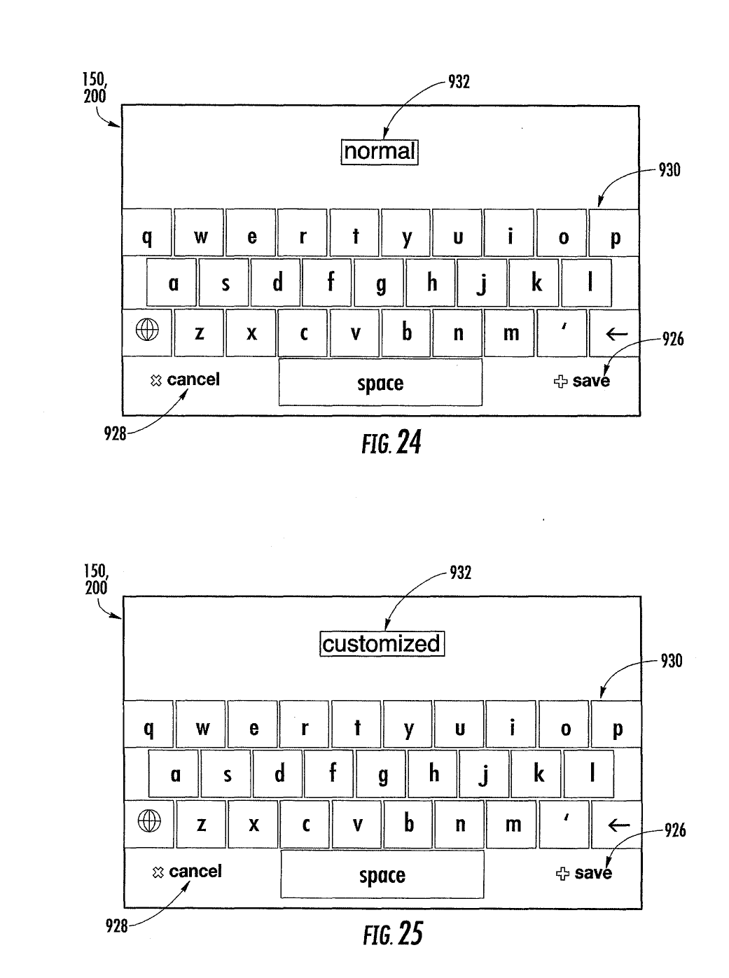

In accordance with one aspect of this disclosure, in response to user selection of the save icon 926 via touch interaction with the respective portion of the display portion 200 shown in FIG. 23, the images on the display portion are updated as shown in FIG. 24, so that a cancel icon 928, virtual keyboard 930 and a text field 932 (e.g., name field) are newly displayed, and the save icon 926 continues to be displayed. The display portion 200 displays the main menu display 210 (e.g., see FIGS. 1-3) in response to user selection of the cancel icon 928.

In response to user selection of the save icon 926 while the virtual keyboard 930 and text field 932 are being displayed, such as shown in FIGS. 24 and 25, the saving of a favorite wash cycle (e.g., a new wash cycle) and a favorite wash cycle icon (e.g., a new wash cycle icon) is initiated. In one example, the favorite wash cycle comprises the settings (e.g., cycle parameters and cycle options) utilized by the wash cycle just completed (e.g., the settings of the wash cycle just completed may have been modified (e.g., modified previously) by way of one or more of the cycle parameter menus 421, options menus 501, delay start menus, cycle parameter bands 900, or the like). The favorite wash cycle icon (e.g., a new wash cycle icon) may comprise the graphic of the wash cycle icon associated with the wash cycle just completed and/or text, wherein the text may be the text included in the text field 932 (e.g., the text of the wash cycle icon associated with the wash cycle just completed, or a different text) when the save icon 926 is selected while the virtual keyboard 930 is being simultaneously displayed, as will be discussed in greater detail below.

Referring to FIG. 24, the text field 932 may initially (e.g., by default) comprise the text of the wash cycle icon associated with the wash cycle that was just completed (e.g., the name of the wash cycle that was just completed), and optionally this text (e.g., name) in the text field 932 may be changed via user touch interaction with the virtual buttons on the virtual keyboard 930. For example, the difference between the image upon the display portion 200 shown in FIG. 24 and the image upon the display portion shown in FIG. 25 is that the name in the text field 932 has been changed to “customized” in response to user selection of the respective virtual buttons of the virtual keyboard 930.

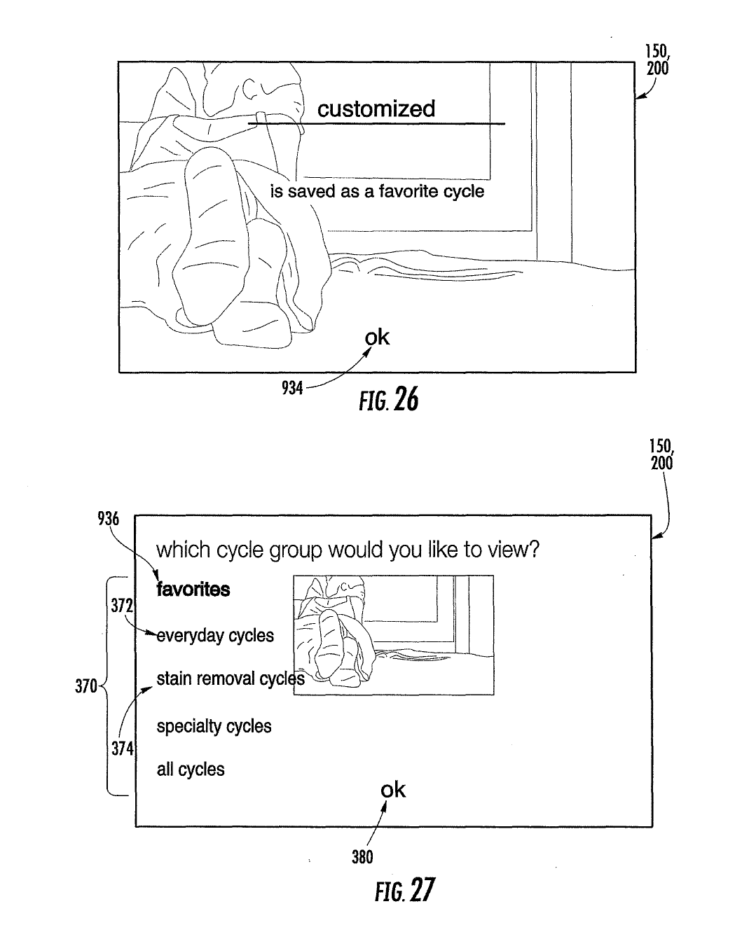

The favorite wash cycle and favorite wash cycle icon (which comprises the text in the text field 932) are stored by the controller device (e.g., a memory associated therewith), which is in communication with the touchscreen user interface 150, in response to user actuation of the save icon 926. Alternatively, the favorite wash cycle and favorite wash cycle icon may be stored in response to user actuation of a confirmation/ok icon 934, such as that shown on the confirmation screen that is shown in FIG. 26 and displayed on the display portion 200 in response to user action of the save icon 926 of FIG. 25. An additional favorite wash cycle and favorite wash cycle icon may be created at the end of each wash cycle by way of the above-discuss method or any other suitable method. Therefore, there may be one or more favorite wash cycles and favorite wash cycle icons.

In accordance with one aspect of this disclosure, any of the favorite wash cycles and the favorite wash cycle icons (e.g., which were created by way of the process discussed immediately above) are made available by way of the touchscreen user interface 150/display portion 200 for selection by the user of the laundry appliance. In this regard and as mentioned above, in response to user actuation of the cycle category icon 360 (FIGS. 1-4), a plurality of cycle group icons 370 (FIGS. 7 and 8) may be displayed on the display portion 200. In accordance with one aspect of this disclosure, prior to any saving of the favorite wash cycle in response to user actuation of the save icon 926 (FIG. 24) and/or the ok icon (FIG. 26), the cycle group icons 370 may optionally include a predetermined number of cycle group icons (e.g., the everyday cycles icon 372, the stain removal cycles icon 374, the specialty cycles icon, and the all cycles icon) available for selection, and thereafter, in response to the saving of a favorite wash cycle (e.g., by way of user actuation of the save icon 926 and/or the ok icon 934), the cycle group icons 370 may be added to, to further include a favorites icon 936, as shown in FIG. 27.

In response to user actuation of the favorites icon 936, and optionally also/thereafter actuation of the ok icon 380, the one or more favorite wash cycle icons are displayed on the display portion 200 and are operative in a manner substantially similar to that discussed above for the wash cycle icons 250. In addition, the one or more favorite wash cycle icons may also be displayed on the display portion 200, with all of the other wash cycle icons 250, in response to user selection of the all cycles icon (which is one of the cycle group icons 370) or the like.

Referring to FIG. 27 and accordance with other aspects of this disclosure, the cycle group icons 370 may always include the favorites icon 936 (even prior to a user saving any favorite wash cycles), and/or a user may create a favorite wash cycle without having to first start the favorite wash cycle and allowing it to be completed. In this regard, when the favorites icon 936 of the plurality of cycle group icons 370 is selected, an Add A Favorite icon (not shown) may be displayed on the display portion 200. Prior to saving any favorite wash cycles, the Add A Favorite icon may be displayed alone on the on the display portion 200. After saving one or more favorite wash cycles in the manner discussed above or below, the Add A Favorite icon may be displayed in series with the icon(s) the one or more favorite wash cycles, wherein the Add A Favorite icon is scrollable and selectable along with/like one of the icons associated with the one or more favorite wash cycles.

The Add A Favorite icon may include text and/or a graphic (e.g., photographic image), as discussed above for the wash cycle icons 250. While viewing the icons for one or more of the favorite wash cycles, the scroll bar icon 300 (FIG. 6) may be activated and operative as discussed above, and an Edit Favorites icon (not shown) may be simultaneously displayed with the scroll bar icon. In response to selecting the Edit Favorites icon, one or more options or commends may be presented on the display portion 200 for being selected by the user, in response to which one or more of the favorite wash cycles (and their associated icons) are cleared or deleted from the saved group of favorite wash cycles. A confirmation screen may be displayed on the display portion 200, for allowing the user to select whether to confirm or cancel any deleting of one or more favorite wash cycles.

In response to selection of the favorites icon 936 of the cycle group icons 370, and thereafter selection of the Add A Favorite icon (not shown), a first screen for adding a favorite wash cycle may be displayed on the display portion. The first screen for adding a favorite wash cycle may include an instructional column with a legend or heading entitled “helpful hints”, and an adjacent cycle menu. The instructional column may include alphanumeric explanation/description that provides use information (e.g., user instructions) for assisting with creating a favorite wash cycle. For example, the instructions in the instructional column may be “select your cycle and then adjust the settings.” The cycle menu may be similar to one of the cycle parameter menus 421 discussed above, except that the cycle menu may list predetermined ones of the wash cycles, for allowing a user to select one of the listed wash cycles. For example, the following wash cycles and/or any other suitable wash cycles may be included in the cycle menu: Deep Clean, Heavy Duty, Whitest Whites, Colors, Normal, Casual, Active Wear, Fast Wash, Delicates, Hand Wash, Rinse And Spin, Jeans, Stuffed Animals, and Pet Beds.

In response to a selection (which may be a default selection that is made automatically) of a wash cycle from the cycle menu of the first screen for adding a favorite, the user may scroll or otherwise transition from the first screen for adding a favorite to a second screen for adding a favorite, so that the second screen for adding a favorite is displayed on the display portion the display portion 200. The second screen for adding a favorite may include the above-discussed cycle parameter menus 421 (FIGS. 11 and 12) and associated features (e.g., the restore icon 450), which may be operative as discussed above, for the wash cycle selected from the cycle menu of the first screen for adding a favorite.

The user may scroll or otherwise transition from the second screen for adding a favorite to a third screen for adding a favorite, so that the third screen for adding a favorite is displayed on the display portion the display portion 200. The third screen for adding a favorite may include the collection of selectable option icons 500 (FIGS. 13 and 14) and associated features (e.g., the restore icon 450), which may be operative as discussed above, for the wash cycle selected from the cycle menu of the first screen for adding a favorite.

Each of the screens for adding a favorite (e.g., the first, second and third screens for adding a favorite that are discussed closely above) may include a cancel icon (e.g., see the cancel icon 928 of FIGS. 24 and 25) and a save icon (e.g., see the save icon 926 FIGS. 24 and 25). The user may select either the cancel icon or the save icon of each of the screens for adding a favorite via touch interaction with the respective portion of the display portion 200. In response to user selection of the cancel icon of one of the screens for adding a favorite, the Add A Favorite icon along with the icon(s) of any currently stored favorite wash cycles are displayed on the display portion 200 along with the cycle category icon 360. In contrast, in response to user selection of the save icon of one of the screens for adding a favorite, process control is transferred so that the images on the display portion 200 are updated, for example, as shown in FIG. 24 and discussed above, and process control may proceed as discussed above with reference to FIGS. 24-26, or the like.

As previously indicated and as will be discussed in greater detail below, the disclosure provided herein related to the washing appliance touchscreen user interface 150 may also be applicable to a touchscreen user interface for a dryer appliance. In this regard and according to some aspects of the present disclosure, the display portion 200 may be capable of displaying a plurality of selectable dry cycle icons (e.g., Normal, Heavy Duty, Express Dry, Jeans, Bulky/Bedding, Delicates, Ultra Delicate, Towels, Touch Up, Casual, Allergen, Time Dry, Casual, Kids Wear, Mixed Loads, Sanitize and Steam Care) associated with a respective dry cycle. As such, one skilled in the art will appreciate that the functionalities of touchscreen user interfaces configured for each of a washing appliance and a dryer appliance may be substantially similar and, as such, the configurations and aspects of a washing appliance controller as disclosed herein may be substantially applicable to a dryer appliance except, for example, the identities of the cycles and associated cycle parameters and options.

Furthermore, the display portion 200 may also be configured to display an error message, indicating that an error has occurred during a wash/dry cycle. The error messages may be generated by detected system events, and the error messages may be identified or otherwise referenced, for example, by an error ID number. In some aspects, the error message may be displayed via an error image (e.g., a “pop-up window”) on the display portion 200. In some instances, the error image may include information for assisting the user in potentially correcting the detected error. For example, the user may be instructed to turn off the main power to the washing appliance, to disconnect the washing appliance from the main power supply, and then to check if the drain pipe or filter is blocked, in an attempt to allow the user to potentially rectify a detected drainage error. Other potential errors or abnormal conditions may be related to a “Door Open” condition (a warning display is presented instructing the user to close the door assembly and actuate the start icon again), an unbalanced load condition (and/or ongoing automatic re-balancing efforts—i.e., a warning display is presented notifying the user that the machine has detected an unbalanced load and is attempting to resolve automatically, for example, by executing a tumbling sequence, wherein the warning display will disappear once the load is re-balanced. If the condition is automatically resolved, a further warning display is presented notifying the user that an unbalanced condition occurred and was automatically resolved), and a sudsing (or over-sudsing) condition (and/or ongoing automatic suds-reduction efforts—i.e., if a suds condition is detected, a warning display is presented notifying the user that the condition has been detected and is being automatically resolved, wherein the warning display will disappear once the condition is resolved. If the condition is automatically resolved, a further warning display is presented notifying the user that a suds condition was detected and was automatically resolved, and may be accompanied by a message to the user suggesting future use of High Efficiency detergent to avoid the condition).

In the case of a dryer appliance, the user may be instructed, for example, to turn off the main power to the dryer appliance, to disconnect the dryer appliance from the main power supply, and then to check if the dryer vent is blocked, in an attempt to allow the user to potentially rectify a detected air flow error. Other potential errors or abnormal conditions may be related to a “Door Open” condition (a warning display is presented instructing the user to close the door assembly and actuate the start icon again), an exhaust restriction condition (if a restriction in the exhaust venting system is detected during a cycle, a warning display is presented instructing the user to refer to the User & Care guide for more information. The same display may also be presented at the end of the cycle), and a failure to meet minimum load size condition (if too small of a load is detected during a cycle, a warning display is presented notifying the user of the load failing to meet a minimum size, for which a correct drying time cannot be estimated. The same display may also be presented at the end of the cycle, recommending that the user use a larger load for future cycles). In this regard, the user may be able to resolve the detected error or other abnormality issue, without requiring the user to place a service call. According to some aspects, the text of the error message may be predetermined with respect to corresponding detectable errors or abnormalities, such that the displayed text may not need to be dynamically generated or is otherwise standardized. In some instances, after power is re-connected to the laundry appliance, the user may be allowed to re-initiate operation of the laundry cycle if the error does not recur. If the error is not resolved by the suggested corrective action, the error message may provide appropriate contact information (e.g., a service assistance number) for assisting the user.

The error image or “pop-up” window may also be implemented to call the user's attention to a particular condition or to advise the user on possible action(s) that could be taken to potentially resolve an issue. The error image may also be accompanied by an aural indicia, such as a particular chime. In some instances, an attention image may be distinguished from an error image in the possible steps which may be taken by the user. For example, the attention image (possibly accompanied by the aural indicia) may advise the user of various corrective steps that could be taken and allow the user to select and implement those steps. In contrast, should an error be detected, the subsequent error image may not allow the user to take any action, other than to advise the user to call for service. The detection of an error may also be accompanied by ceasing the active cycle. Further, the error image may be distinguished from an attention image, for instance, by the color of the image (i.e., an error image may be distinguished by a red component, such as a header, presented in conjunction with the error code). An error image may also be accompanied by an aural indicia, such as a chime.

In addition, the touchscreen user interface 150 may include sleep/standby modes and functionalities. According to some aspects, different time out events of the touchscreen user interface 150 may occur depending on the operational status of the laundry appliance. For example, the laundry appliance may enter a standby mode after five minutes of inactivity, and then enter a sleep mode after thirty minutes of inactivity (i.e., no user interaction with the touchscreen user interface 150). In this regard, when the touchscreen user interface 150 is in the standby mode, the display portion 200 does not include a display, but remains sensitive to a user interaction therewith (i.e., the user touching the display portion 200) to cause a display to re-appear thereon in response to the user interaction. When the touchscreen user interface 150 is in the sleep mode, the display portion 200 does not include a display and, in some instances, may be powered off. In such instances, the display portion 200 may be configured to awaken and provide a display therein in response to physical actuation by the user (e.g., user-actuation of the Power button or actuator).

More particularly, in some instances, the standby mode may be actuated following about 5 minutes of inactivity. In such instances, the backlighting of the display portion 200 may be reduced to about 10%. The sleep mode may then be actuated following about 30 minutes of inactivity, wherein the backlighting of the display portion 200 may be completely shut off. The standby and sleep modes may be implemented when the touchscreen user interface is idle when displaying one of the following: home, preferences, users, cycle settings, cycle options (but not when the selected cycle is being executed). If the display portion is in the standby mode, any detected touch may restore the backlighting to a normal level. However, if the inactivity persists, and the touchscreen user interface enters the sleep mode, and the display portion 200 can be restored by actuating the power actuator for the laundry appliance.

Many modifications and other aspects of the disclosure set forth herein will come to mind to one skilled in the art to which this disclosure pertains having the benefit of the teachings presented in the foregoing descriptions and the associated drawings. For example, in some aspects, the laundry appliance may implement an install cycle or procedure, wherein such an install cycle may be implemented to determine whether the appliance was installed correctly. The duration of such a cycle may be, for example, about 6 minutes for washer and about 4 minutes for dryer. The install cycle, once initiated, may not be configured to be paused, and may only be interrupted by de-actuating the power actuator for the laundry appliance. During such an install cycle, various checks are performed by the controller device and, if a check is not passed, a warning or an alarm display is presented on the display portion 200 and the install cycle is paused. To exit from this condition, the power actuator must be de-actuated or power to the laundry appliance must be disconnected. Checks for a washing machine may include, for example, whether the water tap is open or closed, or whether the drain pipe is properly positioned. Checks for a dryer may include, for example, whether the power service cord was properly installed properly, or whether the gas service is on or off.

As at least alluded to above, all aspects of this disclosure that may have been described in the context of a washer appliance may also relate to a dryer appliance, and vice versa, except for variations noted herein and variations that will be apparent to those of ordinary skill in the art. In this regard, a few representative examples for a dryer appliance are discussed in the following, in accordance with some aspects of this disclosure. Due to the similarities, components of a dryer appliance embodiment that are similar and/or function in at least some ways similarly to corresponding components of the washer appliance embodiment have reference numbers incremented by one thousand. The dryer appliance embodiment of this disclosure is like the washer appliance embodiment of this disclosure, and vice versa, except for variations noted and variations that will be apparent to one of ordinary skill in the art.

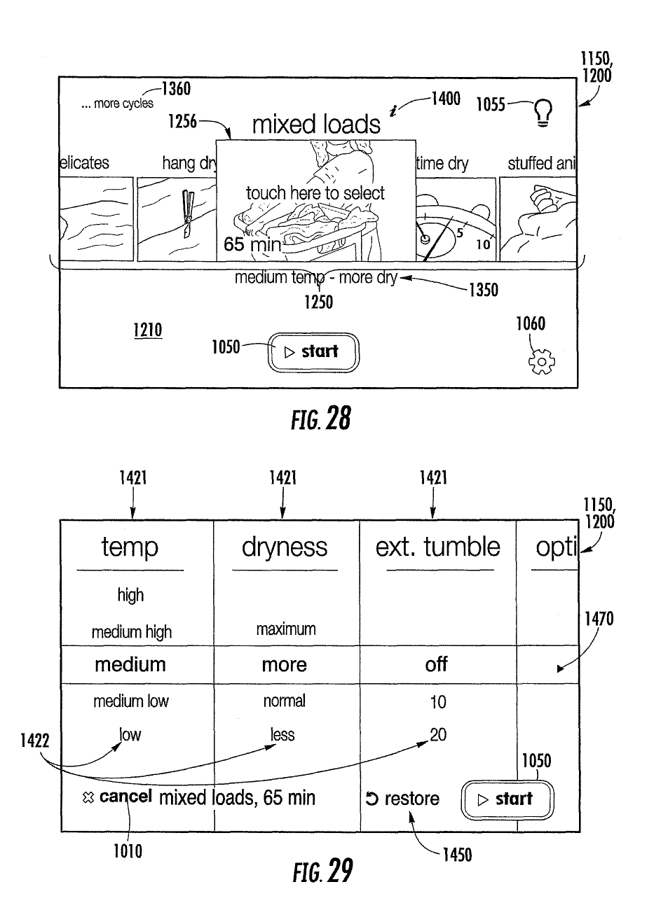

FIGS. 28-31 illustrate a sampling of features of an exemplary touchscreen user interface 1150 for a drying appliance. As shown in FIG. 28, a default arrangement provided on a display portion 1200 of the touchscreen user interface 1150/may be a main menu (home screen) display 1210. The main menu display 1210 on the display portion 1200 may include a plurality of icons associated with the dry cycles and other drying- or machine-related icons (e.g., dry cycle initiation/cycle start icon 1050, light icon 1055, preferences icon 1060, etc.). The main menu display 1210 on the display portion 1200 may present a plurality of selectable dry cycle icons 1250 (e.g., Bulky, Bedding, Towels, Heavy Duty, Perfect Steam, Colors, Echo Cycle, Normal, Casual, Activewear, Fast Dry, Delicates, Hang Dry, Mixed Loads, Time Dry, Stuffed Animals, Pet Beds, Air Clean, Fast Steam, Warm Up, Rugs & Mats, Cashmere, Jeans, Wool, Kidswear, Silk, and Comforter) each associated with a respective dry cycle and being selectable by the user to select the desired dry cycle. In some instances, each dry cycle icon 1250 includes text and/or a graphic particularly indicative of the associated dry cycle. The dry cycle icons 1250 may be more generally referred to as laundry cycle icons. In some particular instances, the graphic of the dry cycle icon 1250 may be a photographic image. For example, the dry cycle recommended or otherwise configured as the default for normal laundry use may be displayed as the text “Mixed Loads” in addition to a graphic (e.g., photographic image), to form the Mixed Loads dry cycle icon 1256, as shown in FIG. 28. In some instances, the dry cycle icons 1250 may be displayed on the display portion 1200 in a series or otherwise linearly along a horizontally-displayed row or a vertically-displayed column According to some aspects, the dry cycle icons 1250 may be displayed in multiple series on the display portion 1200, in rows, columns, or combinations thereof. That is, a first series of the dry cycle icons 1250 could be provided on one side of the display portion 1200, while a second series of dry cycle icons 1250 could be provided on the opposing or adjacent side of the display portion 1200, in rows, columns or a combination thereof.

As mentioned previously, a selected one of the dry cycle icons 1250 may be visually-distinguished, or otherwise visually indicated, as selected when the user interacts via user touch interaction with the selected one of the dry cycle icons 1250. According to one aspect of the present disclosure, the selected one of the dry cycle icon 1250 may be centered and enlarged upon selection thereof. For example, as shown in FIG. 28, the Mixed Loads dry cycle icon 1256 is indicated as the selected dry cycle due to its centered positioned and enlarged size, indicating to the user that actuation of the cycle start icon 1050 would cause the Mixed Loads dry cycle to be implemented. In one particular aspect, both the text and the graphic (e.g., photographic image) of the selected dry cycle icon 1250 are enlarged compared to the non-selected dry cycle icons 1250. It is within the scope of this disclosure for a dry cycle icon 1250 to be indicated as being selected by various combinations of modifications to the text and graphic of the selected icon, and by way of visually distinguishing using techniques other than, or in addition to, the centering and/or enlarging disclosed herein.

According to some aspects of the present disclosure, only a limited (i.e., less than the total amount of dry cycle icons) or a predetermined amount of the dry cycle icons 1250 within the series may be visibly displayed on the display portion 1200 at any time. For example, as shown in FIG. 28, only five dry cycle icons 1250 are displayed (e.g., at least partially displayed) on the display portion 1200 concurrently, while one or more of the other dry cycles are also available for selection. However, the one or more of the other dry cycle icons 1250 are not visibly displayed on the display portion 1200. One skilled in the art will appreciate, though, that this exemplary configuration is not intended to limit the present disclosure. In this regard, any number of dry cycle icons 1250 may be concurrently displayed on the display portion 1200 at any time, including all available dry cycle icons 1250 in the series.

In accordance with one aspect of this disclosure, the selected dry cycle icon 1250 is centered and enlarged within the series of dry cycle icons (e.g., within the series of dry cycle icons that are being simultaneously displayed on the display portion 1200 with the selected dry cycle icon). For example and as shown in FIG. 28, the selected dry cycle icon 1250, which is centered and enlarged, is displayed on the display portion 1200 with at least a portion of at least one other of the dry cycle icons. More specifically, the selected dry cycle icon 1250, which is centered and enlarged, is displayed on the display portion 1200 with at least a portion of a plurality of the other dry cycle icons. In addition, each of the one or more dry cycle icons 1250 that are adjacent to the selected dry cycle icon 1250, which is centered and enlarged, may be only partially displayed (e.g., may be truncated) on the display portion 1200, to make room for the enlargement of the selected dry cycle icon 1250. In accordance with one aspect, each of the plurality of the dry cycle icons 1250 that are concurrently displayed on the display portion 1200 with the selected dry cycle icon 1250, which is centered and enlarged, may be selected via user touch interaction with the touchscreen user interface 1150, to change the dry cycle icon that is presently selected (i.e., centered and enlarged).

In instances where only a predetermined amount of dry cycle icons 1250 are displayed concurrently (i.e., one or more of the other dry cycles are available for selection, but are not displayed), the series of dry cycle icons 1250 may be configured to be scrollable with respect to the display portion 1200 such that the user can scroll through the dry cycle icons 1250 to view the non-displayed other dry cycle icons 1250. That is, the series of dry cycle icons 1250 may be laterally (rows) or vertically (columns) scrollable, in either direction, to allow the user to view or otherwise scroll among the series of dry cycle icons 1250. In this regard, the series of dry cycle icons 1250 may be scrollable in either direction. The scrolling action of the series of dry cycle icons 1250 can occur in a number of ways via user touch interaction with the display portion 1200, for example as discussed above for the series of wash cycle icons 250 (FIGS. 2-6).

Referring to FIG. 28 and according to some aspects of the present disclosure, an initial selection of one of the dry cycle icons 1250 displayed on the display portion 1200 causes primary parameter icons 1350 (e.g., cycle parameter indicia), which are associated with the selected dry cycle, to be displayed on the display portion 1200. In some instances, the series of dry cycles 1250 may include a designated default dry cycle such as, for example, the Mixed Loads dry cycle, such that the initial display on the display portion 1200 includes the centered and enlarged Mixed Loads dry cycle icon 1256 on the display portion 1200, with the primary parameter icons 1350 being displayed adjacent thereto on the display portion 1200. The primary parameter icons 1350 may be indicative of parameters common to all of the dry cycles, such as, for example, the drying temperature and the extent of the drying to be done. In some instances, the primary parameter icons 1350 may be displayed adjacent to the series of dry cycle icons 1250. For example and as shown in FIG. 28, the primary parameter icons 1350 may be displayed vertically-adjacent to a horizontal row of the selectable dry cycle icons 1250.

The primary parameter icons 1350 may be set to default values of each respective dry cycle such that, upon selection of a particular dry cycle by a user via the associated dry cycle icon 1250, the primary parameter icons 1350 reflect the default values of that particular dry cycle. For example, as shown in FIG. 28, a selection of the Mixed Loads dry cycle icon 1256 causes at least some of the primary parameter icons 1350 to display the default values associated therewith. For example and as shown in FIG. 28, the primary parameter icons 1350 include a drying temperature parameter icon that is associated with and indicates a default value of “medium temp” and a dryness parameter icon that is associated with and indicates a default value of “more dry” when the Mixed Loads dry cycle icon 1256 is selected. The default values of the primary parameter icons 1350, associated with the selected dry cycle, may be indicated on the display portion 1200 using textual indicia, numerical indicia, or any other suitable indicia. Further, the primary parameter icons 1350 may display appropriate graphics (e.g., a thermometer for the temperature parameter(s)) for indicating to the user the particular parameter or value thereof associated with the primary parameter icon 1350.

According to some aspects of the present disclosure, the primary parameter icons 1350 may only be displayed on the display portion 1200 when the associated dry cycle icon 1250 is selected (e.g., centered and enlarged) on the display portion 1200. In this regard, scrolling the series of dry cycle icons 1250 such that the initially-selected or default dry cycle icon 1250 is no longer centered and enlarged, in turn, causes the primary parameter icons 1350 associated with the initially-selected or default dry cycle icon 1250 to be removed from the display portion 1200.

According to some aspects of this disclosure, a cycle category icon 1360 may be displayed on the display portion 1200, as shown in FIG. 28. In response to user actuation of the cycle category icon 1360, a plurality of cycle group icons may be displayed on the display portion 1200 (e.g., see the cycle group icons 370 shown in FIGS. 7, 8 and 27 for the washer embodiment). The dry cycles are typically grouped into selectable categories (e.g., everyday cycles, specialty cycles and all cycles, and optionally also favorites), with each category being associated with a respectively named, or otherwise identified, icon of the plurality of cycle group icons. In response to user selection of one of the icons of the plurality of cycle group icons (i.e., user selection of a particular group of dry cycles), the selected category of dry cycles (i.e., the dry cycle icons 1250 corresponding to the selected category of dry cycles) replaces the previous category of dry cycles (i.e., the dry cycle icons 1250 corresponding to the previous category of dry cycles) displayed on the display portion 1200.

According to some aspects of the present disclosure, a selectable information icon 1400 may be displayed on the display portion 1200, as shown in FIG. 28. In some instances, the information icon 1400 may be displayed adjacent to the centered and enlarged, initially selected dry cycle icon 1250. User actuation of the information icon 1400 may cause information, or other features (e.g., icons) associated with the dry cycle associated with the initially selected dry cycle icon 1250, to be displayed on the display portion 1200 (e.g., see the alphanumeric descriptive information displayed and schematically shown as being scrolled through in FIGS. 9 and 10 for the washer embodiment). For example, while the Mixed Loads dry cycle icon 1256 is selected, user touch interaction with the information icon 1400 may cause a description of the Mixed Loads dry cycle to be displayed on the (dimmed) Mixed Loads dry cycle icon 1256 on the display portion 1200. In some instances, the provided description may be vertically or laterally scrollable via user touch interaction such that the complete description can be read by the user.

According to some aspects of the present disclosure, a subsequent selection of the currently selected dry cycle icon 1250 displayed on the display portion 1200 (i.e., the centered and enlarged dry cycle icon 1250) optionally causes the enlarged dry cycle icon 1250 to become further enlarged (e.g., fully enlarged, so as to occupy substantially all of the display portion 1200), and further causes a plurality of cycle parameter menus 1421 associated with the selected dry cycle to be displayed on the display portion 1200, as shown in FIG. 29. In addition, the non-selected dry cycle icons 1250 may be at least partially removed, or fully removed, from the display portion 1200, as shown in FIG. 29. The cycle parameter menus 1421 are indicative of parameters, such as, for example, drying air temperature, target dryness of laundry, and extended tumble (i.e., extended rotation of the rotatable laundry-containing drum of the dryer appliance), associated with each respective dry cycle. That is, the cycle parameter menus 1421 include each of temp, dryness and extended tumble menus. For example, the enlarged display that includes the cycle parameter menus 1421 may include a listing of the selectable values (e.g., cycle settings) associated with each cycle parameter menu in a scrollable column A desired value for each cycle parameter menu 1421 may be selectable by touch interaction with the desired value/the respective portion of the display portion 1200 of the touchscreen user interface 1150. According to some aspects, a desired value for each cycle parameter menu 1421 may be selectable by way of scrolling through the associated list of selectable values. In some instances, the scrolling motion of the various selectable values associated with each cycle parameter menu 1421 may be similar to that of a slot machine in which value icons 1422 (e.g., textual indicia) associated with the cycle parameter appear to move vertically (e.g., rotatably move vertically) and, in some instances, move vertically off of and onto the display portion 1200. In some aspects, the scrolling action may be caused by a user selecting one of the non-selected parameter values (e.g., selecting one of the value icons 1422), thereby causing the selected cycle parameter value/value icon 1422 to move to the center of the vertical column of the respective cycle parameter menu. In some instances, the parameters values/value icons 1422 may be vertically scrollable via a swiping/brushing user touch interaction, as described previously, in a vertical direction over the value icons 1422 of the cycle parameter menus 1421.

The cycle parameter values/value icons 1422 of the cycle parameter menus 1421 may be set to predetermined default values, such that when a dry cycle is selected via the associated dry cycle icon 1250 and then the cycle parameter menus are displayed for the selected dry cycle, the displayed cycle parameter menus show the default values of the cycle parameters as being selected. In some instances, the selected cycle parameter values/value icons 1422 may be visually distinguished such that the user is informed of the current cycle parameter selections, as shown in FIG. 29. Upon first causing the cycle parameter menus 1421 to be displayed, the cycle parameter values may typically be set to default parameters associated with the selected dry cycle. For example, as shown in FIG. 29, the default cycle parameters associated with the Mixed Loads dry cycle may include a medium drying air temperature, a more (e.g., more than normal) target dryness of the laundry, and no extended tumble, wherein these default parameter values/value icons 1422 are visually distinguished. The default parameter values/value icons 1422 may be visually distinguished by being centered in the respective cycle parameter menus 1421/vertical columns and highlighted to indicate their current selection. For example, this highlighting may be by way of a substantially single, central and horizontally extending region that is highlighted or otherwise distinguished. The cycle parameters values associated with the Mixed Loads dry cycle may be changed via scrolling of the value icons 1422 associated with the cycle parameters, or in any other suitable manner, such as discussed above. A restore icon 1450 may be selected by a user in order to automatically return the parameter cycle settings of the selected dry cycle to their default values/default parameter cycle settings.

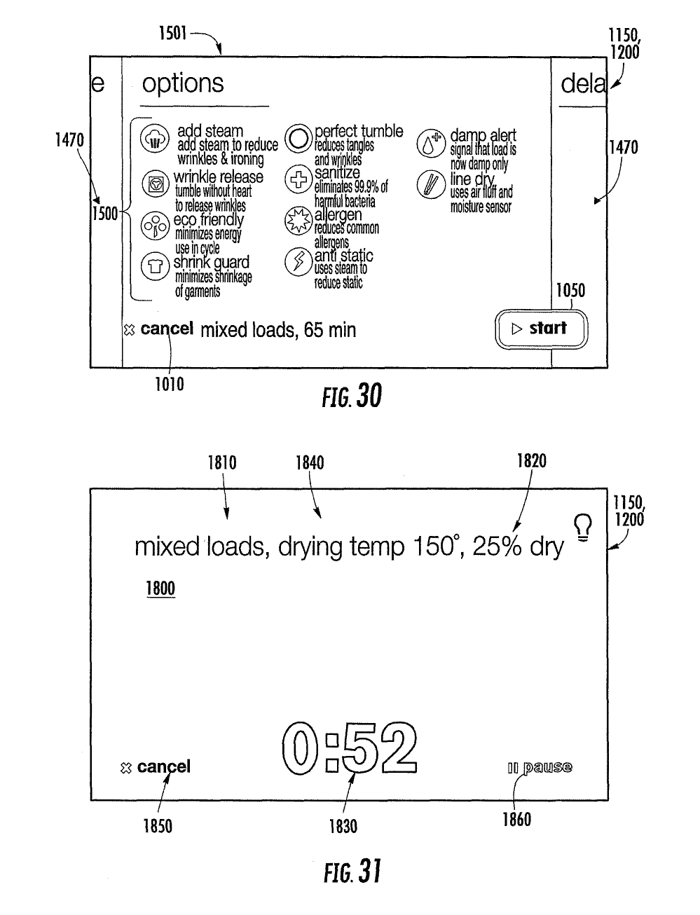

Furthermore, the plurality of cycle parameter menus 1421 shown in FIG. 29 may be laterally scrollable upon (e.g., off of) the display portion 1200 so that the display portion 1200 displays (e.g., more fully displays) one or more other cycle parameter menus. The plurality of cycle parameter menus 1421 may be laterally scrolled relative to the display portion 1200 in response to user selection of an actuatable directional icon 1470, or in response to any other suitable user interaction with the touchscreen user interface 1150. More specifically, an options menu 1501, which is shown in FIG. 30 and has a collection of selectable option icons 1500 associated with the selected dry cycle, may be scrolled to in response to user selection of the actuatable directional icon 1470 shown in FIG. 29.

Referring to FIG. 30, each option icon 1500 corresponds to a respective cycle option that may be implemented for (e.g., incorporated into) one or more of the dry cycles. In some instances, the collection of selectable option icons 1500 may be superimposed on the enlarged and dimmed image associated with the selected dry cycle icon 1250, such that the enlarged image forms a background on the display portion 1200. User selection of one of the option icons 1500 may cause the selected option icon 1500 to be visually-distinguished, highlighted or otherwise visually indicated as selected when the user interacts therewith. Furthermore, according to some aspects, the option icon for any option not recommended or otherwise unavailable for a particular dry cycle may be rendered non-selectable in the collection of option icons 1500. For example, the non-selectable options may be indicated by a “graying-out” of the textual/graphical indicia associated with the non-selectable option icons of the collection of selectable option icons 1500. In this regard, the visual contrast between the textual/graphical indicia of the non-selectable option icons and the enlarged image may be decreased such that the textual/graphical indicia is only dimly or faintly visible to the user. However, any suitable visual indicia or indication may be provided to indicate that an option is not recommended or available for use. In some instances, an aural indicia (e.g., a beeping sound) may be provided to the user when interacting with a non-selectable option to indicate that the option is non-selectable. In addition, selecting and/or changing any one of the option icons 1500 may cause a restore icon to be displayed. The restore icon may be selected by the user for returning the selected dry cycle to its default options settings. The user may select the cancel icons 1010 of FIGS. 29 and 30 to return to the main menu display 1210 (FIG. 28).

The options menu 1501 shown in FIG. 30 may be laterally scrollable upon (e.g., off of) the display portion 1200 so that the display portion 1200 displays (e.g., more fully displays) one or more of the cycle parameter menus 1421 (FIG. 29). The options menu 1501 may be laterally scrolled relative to the display portion 1200 in response to user selection of the actuatable directional icons 1470 of FIG. 30, or in response to any other suitable user interaction with the touchscreen user interface 1150. More specifically, a delay start menu (e.g., see the delay start menu shown in FIGS. 15 and 16 for the washer embodiment) may be scrolled to in response to user selection of/touch interaction with the respective directional icon 1470.

Upon initiation of the selected dry cycle via user selection of the cycle start icon 1050, a dry cycle status display 1800 may be displayed on the display portion 1200, as shown in FIG. 31. In some instances, various dry cycle status indicators (e.g., indicia) may be displayed on the dry cycle status display 1800. For example, the dry cycle status indicators may include an indicia of the selected dry cycle 1810, a value 1820 indicative of the present dryness of the laundry in the dryer appliance, a dry cycle countdown timer 1830 and/or a primary parameter icon 1840 (e.g., cycle parameter indicia). In accordance with one aspect of this disclosure, the primary parameter icon 1840 includes indicia and/or graphics indicative of a relevant parameter of the dry cycle being implemented. In some instances, the dry cycle status indicators may be superimposed on the enlarged image of the dry cycle icon 1250 associated with the implemented dry cycle. Alternatively or in addition, the dry cycle status indicators may further include animation indicative of the status of the dry cycle being performed. This optional animation may be full motion computer graphics, and/or alternatively recorded video, indicative of the status of the dry cycle being performed.

The dry cycle status display 1800 displayed on the display portion 1200, as shown for example in FIG. 31, may also include a selectable cancel icon 1850 displayed for selection by the user, and user selection of the cancel icon 1850 causes cancellation of the implemented dry cycle and a return to the main menu display 1210 (FIG. 28). In addition, a selectable pause/stop icon 1860 may be displayed on the dry cycle status display 1800, and user selection of the pause icon 1860 causes pausing or otherwise stops progress of the implemented dry cycle.

In response to user selection of the pause icon 1860, a cycle parameter band (e.g., see the cycle parameter band 900 shown in FIGS. 20 and 21 for the washer embodiment) may appear on the display portion 1200 to indicate the currently selected cycle parameters. If the user wishes to simply add an article of laundry to the dryer appliance, the user does so and may actuate a resume icon that is displayed on the display portion 1200 with the cycle parameter band. Upon re-starting the selected dry cycle, the interrupted cycle may continue (i.e., time-wise) from the point at which it was interrupted by the user. In other instances, instead of adding an article of laundry, the user may actuate a cancel icon that is displayed on the display portion 1200 with the cycle parameter band. Actuation of the cancel icon causes the selected dry cycle to be cancelled, and the display portion 1200 returns to a display of the main menu display 1210.

The cycle parameter band includes primary parameter icons indicative of at least some of the values and/or settings of the primary parameters of the dry cycle that has been paused in response to user selection of the pause icon 1860. Each of the primary parameter icons (e.g., cycle parameter indicia) included in the cycle parameter band may be actuated via user touch interaction to display other values or settings of the cycle parameters that are available for being selected and used in the presently selected, and paused, dry cycle. For example, the other values or settings of the cycle parameters that are available for being selected may be displayed by way of menus, or the like, and/or they may be provided in scrollable configurations. As a more specific example, the values or settings of the cycle parameters that are available for being selected may be displayed and selected in a manner similar to that which was discussed above with reference to the cycle parameter menus 1421 of FIG. 29. By way of the cycle parameter band, the user may select a different value or setting of a cycle parameter to be implemented in the remainder of the presently selected dry cycle upon resumption of the dry cycle.

Numerous other aspects of the dryer appliance embodiment of this disclosure should be apparent to those of ordinary skill in the art since, for example, the dryer appliance embodiment of this disclosure is like the washer appliance embodiment of this disclosure, except for variations noted and variations that will be apparent to one of ordinary skill in the art.

Whereas exemplary embodiments have been described above often in the context of laundry appliances, features of this disclosure have applicability to other types of appliances, such as to a suite of kitchen and laundry appliances. Accordingly, in one aspect of this disclosure, references to “laundry” may be omitted or replaced with an identifier of another type or class of appliances, such as kitchen appliances. That is and for example, the appliances of this disclosure may be kitchen and/or laundry appliances, although other types of appliances are also within the scope of this disclosure. The kitchen appliance(s) may be one or more of an oven, stove, range, warmer, toaster, dishwasher, refrigerator, freezer, and coffee maker, or the like. The laundry appliance(s) may be one or more of a laundry washer and/or a laundry dryer, or the like. Other types of appliances are also within the scope of this disclosure.

The entire disclosure of International Application No. PCT/US2011/067756, which has published as Pub. No. WO/2012/092445, is incorporated herein by reference.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

1-91. (canceled)

92. A laundry appliance, comprising:
a controller device being configured to direct operation of at least one operational component associated with the laundry appliance; and
a touchscreen user interface in communication with the controller device, the controller device being responsive to at least one user selection via the touchscreen user interface to direct operation of the at least one operational component, the touchscreen user interface having a display screen for displaying a series of laundry cycle icons, each laundry cycle icon being associated with a respective laundry cycle capable of being implemented via the controller device, each laundry cycle icon being individually selectable as at least one user selection via user touch interaction with the touchscreen user interface, and a selected one of the displayed laundry cycle icons being centered and enlarged within at least a portion of the series of laundry cycle icons, to indicate selection of the selected one of the displayed laundry cycle icons.

93. The laundry appliance according to claim 92, wherein simultaneously with the selected one of the displayed laundry cycle icons being centered and enlarged, at least one of the displayed laundry cycle icons that is adjacent to the selected one of the displayed laundry cycle icons is only partially displayed on the display screen.

94. The laundry appliance according to claim 92, wherein the touchscreen user interface is configured to further enlarge the centered and enlarged laundry cycle icon in response to user interaction with the centered and enlarged laundry cycle icon.

95. The laundry appliance according to claim 92, wherein the touchscreen user interface is configured to display at least one scrollable series of selectable cycle parameter icons on the display screen at least partially in response to user interaction with the centered and enlarged laundry cycle icon.

96. The laundry appliance according to claim 92, wherein the touchscreen user interface is configured to display a collection of selectable option icons on the display screen at least partially in response to user interaction with the centered and enlarged laundry cycle icon.

97. The laundry appliance according to claim 92, wherein the touchscreen user interface is configured to display at least one selectable delay start option icon on the display screen at least partially in response to user interaction with the centered and enlarged laundry cycle icon.

98. The laundry appliance according to claim 92, wherein the touchscreen user interface is configured to be responsive to a directional user swipe interaction therewith, in relation to a predetermined number of the laundry cycle icons, of the series of laundry cycle icons, displayed on the display screen, to scroll the series of laundry cycle icons in at least one of first and second scrolling directions.

99. The laundry appliance according to claim 92, wherein the touchscreen user interface is configured to display a scroll bar adjacent to a predetermined number of the laundry cycle icons of the series of laundry cycle icons displayed on the display screen, in response to extended user interaction with at least one of the laundry cycle icons of the series of laundry cycle icons displayed on the display screen, the scroll bar having a slider icon movable in first and second scrolling directions via user touch interaction with the touchscreen user interface to scroll the series of laundry cycle icons in the first and second scrolling directions.

100. The laundry appliance according to claim 92, wherein the touchscreen user interface is configured to display a predetermined number of the laundry cycle icons, of the series of laundry cycle icons, on the display screen for user selection, the predetermined number of the laundry cycle icons being less than a total number of the laundry cycle icons in the series.

101. The laundry appliance according to claim 92, wherein the touchscreen user interface is configured to display indicia indicative of at least one default cycle parameter associated with the laundry cycle associated with the centered and enlarged laundry cycle icon, and the indicia is displayed simultaneously with, and proximate, the centered and enlarged laundry cycle icon.

102. The laundry appliance according to claim 92, wherein the touchscreen user interface is configured to display a cycle start icon on the display screen, the cycle start icon being actuatable to direct the controller device to initiate the laundry cycle associated with the centered and enlarged laundry cycle icon.

103. The laundry appliance according to claim 92, wherein the touchscreen user interface is configured such that the series of laundry cycle icons is non-endlessly scrollable across the display screen.

104. The laundry appliance according to claim 92, wherein each laundry cycle icon comprises an image and an alphanumeric caption indicative of a laundry cycle associated therewith.

105. The laundry appliance according to claim 104, wherein the touchscreen user interface is configured to display the image associated with a respective laundry cycle icon as a photographic image.

106. A method of controlling a laundry appliance, comprising:
displaying a series of laundry cycle icons on a display screen of a touchscreen user interface associated with the laundry appliance, the touchscreen user interface being in communication with a controller device configured to direct operation of at least one operational component associated with the laundry appliance in response to at least one user selection via the touchscreen user interface, each laundry cycle icon being associated with a respective laundry cycle capable of being implemented via the controller device, and each laundry cycle icon being individually selectable via the at least one user selection via user touch interaction with the touchscreen user interface; and
centering and enlarging one of the displayed laundry cycle icons within at least a portion of the series of laundry cycle icons on the display screen in response to the one of the displayed laundry cycle icons being selected via the at least one user selection via user touch interaction with the touchscreen user interface.

107. The method according to claim 106, further comprising scrolling the series of laundry cycle icons across the display screen in at least one of first and second scrolling directions, in response to a directional user swipe interaction with the touchscreen user interface, in relation to the series of laundry cycle icons.

108. The method according to claim 106, further comprising displaying a scroll bar adjacent to a predetermined number of the laundry cycle icons of the series of laundry cycle icons displayed on the display screen, in response to predetermined user touch interaction with the touchscreen user interface, the scroll bar having a slider icon movable in first and second scrolling directions via user touch interaction with the touchscreen user interface; and scrolling the series of laundry cycle icons across the display screen in one of the first and second scrolling directions, in response to the user moving the slider icon in one of the first and second scrolling directions.

109. The method according to claim 106, wherein displaying a series of laundry cycle icons comprises displaying a predetermined number of the laundry cycle icons in the series of laundry cycle icons on the display screen for user selection, the predetermined number of the laundry cycle icons being less than a total number of the laundry cycle icons in the series.

110. The method according to claim 106, further comprising removing at least one of the laundry cycle icons from the display screen, further enlarging the centered and enlarged laundry cycle icon, and displaying at least one scrollable series of selectable cycle parameter icons on the display screen, at least partially in response to user interaction with the centered and enlarged laundry cycle icon.

111. The method according to claim 106, further comprising removing at least one of the laundry cycle icons from the display screen, further enlarging the centered and enlarged laundry cycle icon, and displaying a collection of selectable option icons, at least partially in response to user interaction with the centered and enlarged laundry cycle icon.

112. The method according to claim 106, further comprising removing at least one of the laundry cycle icons from the display screen, further enlarging the centered and enlarged laundry cycle icon, and displaying at least one selectable delay start option icon on the display screen, at least partially in response to user interaction with the centered and enlarged laundry cycle icon.

113. The method according to claim 106, further comprising displaying an indicia indicative of at least one default cycle parameter associated with the laundry cycle associated with the centered and enlarged laundry cycle icon, wherein the displaying of the indicia indicative of at least one default cycle parameter and the centering and enlarging one of the displayed laundry cycle icons on the display screen occur substantially simultaneously.

114. The method according to claim 106, further comprising displaying a cycle start icon on the display screen, the cycle start icon being actuatable to direct the controller device to initiate the laundry cycle associated with the centered and enlarged laundry cycle icon.

115. The method according to claim 106, comprising non-endlessly scrolling the series of laundry cycle icons across the display screen.

116. The method according to claim 106, wherein displaying a series of laundry cycle icons comprises displaying each laundry cycle icon on the display screen as an image and an alphanumeric caption indicative of a laundry cycle associated therewith.

117. The method according to claim 116, wherein the image associated with a respective laundry cycle icon is a photographic image indicative of a laundry cycle associated therewith.
